(19) United States
(12) Patent Application Publication
(10) Pub. No.: US 2022/0112362 A1
(43) Pub. Date: Apr. 14, 2022

(54) Thermoplastic Vulcanizate Compositions Their Preparation and Use in Flexible Tubular Pipes

(71) Applicant: ExxonMobil Chemical Patents Inc., Baytown, TX (US)

(72) Inventors: Krishnan Anantha Narayana Iyer, Manvel, TX (US); Antonios K. Doufas, Houston, TX (US); Anthony J. Dias, Houston, TX (US); Andrew A. Takacs, Houston, TX (US)

(21) Appl. No.: 17/275,521

(22) PCT Filed: Sep. 9, 2019
(86) PCT No.: PCT/US2019/050131

§ 371 Date: Mar. 11, 2021

Related U.S. Application Data
(60) Provisional application No. 62/731,189, filed on Sep. 14, 2018.

(30) Foreign Application Priority Data
Oct. 22, 2018 (EP) 18201721.0

(51) Int. Cl. C08L 19/00; C08L 9/06; F16L 11/08

(52) U.S. Cl. CPC C08L 19/003; F16L 11/08; C08L 9/06

(57) ABSTRACT

A flexible pipe for transporting fluids in hydrocarbon production. The flexible pipe includes at least one layer comprised of a thermoplastic vulcanizate (TPV) composition. In one embodiment, the TPV composition further includes a cyclic olefin copolymer present in a range from 0.1 wt % to 30 wt % based upon a total weight of the TPV composition. In another embodiment, the TPV composition further includes a hydrocarbon resin present in a range from 0.1 wt % to 30 wt % based upon a total weight of the TPV composition. In another embodiment, the TPV composition further includes a slip agent present in a range from 0.1 wt % to 30 wt % based upon a total weight of the TPV composition. In another embodiment, the TPV composition further includes a silicon hydride reducing agent compound with at least two Si—H groups. In another embodiment, the TPV composition further includes a polyolefin based compatibilizer. In another embodiment, the TPV composition has an abrasion resistance of 75 mg/1000 cycle or less. In another embodiment, the TPV composition has a CO₂ gas permeability greater than 10 barrers.

### PRIORITY

This application claims priority to Provisional Application No. 62/731,189, filed Sep. 14, 2018, and EP 18201721.0, filed Oct. 22, 2018, the disclosures of which are incorporated herein by their reference.

### FIELD

The present disclosure relates to thermoplastic vulcanizate compositions exhibiting desirable properties, such as permeability properties, abrasion resistance, creep, fatigue resistance or thermal conductivity. In one aspect, the present disclosure more specifically relates to using thermoplastic vulcanizate compositions in flexible tubular pipes for transporting fluids for onshore or offshore oil production.

### BACKGROUND

Flexible pipes, such as flexible subsea pipes and subsea umbilicals, as well as flexible pipes combining the functions of flexible pipes and subsea umbilicals, are utilized by the oil and gas industry to transport production fluids, such as oil, gas, and/or water, from one location to another. Flexible pipes are particularly useful in connecting a subsea location to a sea level location. Flexible pipes are formed by a set of different layers, each intended to allow the pipe to withstand the stresses of offshore service. Such flexible pipes include multiple polymeric sheaths and reinforcing layers formed by winding of shaped metallic wires, hoops or filaments.

Flexible pipes are further described in the standardized documents published by the American Petroleum Institute (API), such as documents API 17J and API RP 17B. Flexible pipes usually include at least one extruded polymer layer forming an inner tube often called the pressure sheath intended to convey the transported fluid, armoring layers of metal around the inner tube, and an external polymeric protective sheath called the external sheath around the reinforcing layers. Such flexible pipes can include an optional carcass layer within the pressure sheath to provide collapse resistance. The pressure sheath is previously produced by continuous extrusion of a polymers that show excellent resistance to crude oil such as polyamide-11 (PA11), polyethylene (PE) and poly(vinylidene difluoride) (PVDF). Typical unbonded flexible pipes are disclosed in U.S. Pat. Nos. 6,123,114, 9,012,001, and 6,085,799.

Such flexible pipes can include intermediate polymeric sheaths that are provided between the internal pressure sheath and the external protective sheath, such as for example between two reinforcing layers. When provided, such intermediate sheath prevents at least two of these armor plys from being directly in contact with each other, something which would cause them to wear prematurely. EP 0 929 767 and U.S. Pat. No. 7,770,603 describes a pipe equipped with such an intermediate anti-wear layer. Such an anti-wear layer is produced by helically winding an anti-wear tape obtained by extruding a polyamide-based or polyolefin-based plastic. However, these intermediate layers rapidly deteriorate due to abrasion with the armor plys when the flexible pipes undergo large stresses, such as those encountered in offshore oilfields. Therefore, there is a need to develop new polymeric materials that are useful as anti-wear layer that can be obtained for an advantageous cost.

In deep and ultra-deep water environments the low ocean floor temperature increases the risk of production fluids cooling to a temperature which may lead to pipe blockage. For example, cooling of crude oil can result in paraffin formation resulting in the blockage of the internal bore of the flexible pipe. The flexible pipe may further include a thermal insulation layer arranged between the reinforcing layers and the external protective sheath. This thermal insulation layer is generally made by helically winding of syntactic foams. Such syntactic foams consist of a polypropylene matrix with embedded non-polymeric (e.g., glass) microspheres. A major disadvantage for such syntactic PP foam tapes is that they involve two manufacturing steps: producing the insulation tape and winding the tape onto the pipe body. A further disadvantage of such extruded tapes include the corrosion of steel or metal wires forming the layers due to condensation of water vapor migrating from the inner layer through the insulation tapes. A still further disadvantage of existing insulation technology is that in the case of damage to the external sheath, the annulus of the flexible pipe can get flooded which increases the risk of corrosion of the metal armor wires. U.S. Pat. No. 8,210,212 teaches the use of an extruded insulation layer composed of a foamed polymeric layer. However, such foamed polymeric insulation layers are prone to crushing and internal and external pressures operate to squeeze the tape layer thereby reducing its thickness and thermal insulation properties. Therefore, there is significant interest in providing an extrudable, dense thermal insulation layer with improved insulation properties.

The build-up of acid gases, such as, hydrogen sulfide and carbon dioxide, in the annulus are liable to corrode the elements of the flexible pipe. The build-up of acid gases can cause the external sheath to burst when the pressure in the annular region exceeds the external pressure, particularly near the surface of the sea. This condensation problem may in particular be critical in what are called S or wave (lazy-S, steep-S) configurations. U.S. Pat. No. 4,402,346 describes a pipe wherein the armoring is surrounded by a permeable external sheath, which has the advantage that aggressive gases diffusing through the liner will not be accumulated in the volume around the armor plys. The current polymeric materials used for external sheath such as high density polyethylene, and polyamide-11 (PA11) have extremely low permeability for the acid gases, thereby further exacerbating the corrosion. Therefore, there is a need to develop new polymeric materials that have excellent abrasion resistance and high permeability for use in external sheath of flexible pipes.

The polymeric external sheath described above can also be employed in a subsea umbilicals. Subsea umbilicals consist of an assembly of one or more internal sealing tubes, and optionally electrical cables and/or fiber-optic cables. The assembly is made by helicoid or S/Z winding of the tubes and cables so that the umbilical is flexible. The assembly may be surrounded by reinforcing layers and an external polymeric protective sheath. These internal sealing tubes, the function of which is to transport the aforementioned fluid, generally have a diameter very much less than the external diameter of umbilical. An internal sealing tube of an umbilical generally consists of either a metal sealing tube or an impermeable polymeric tube surrounded by one or more reinforcing layers. Such subsea umbilicals are described in API 17E “Specification for subsea umbilicals”. External polymeric sheaths useful for subsea umbilicals require exceptionally high flexibility and abrasion resistance. Therefore, there is a need to develop new polymeric materials that have excellent abrasion resistance and high permeability for use in external sheath of flexible pipes.

U.S. Pat. Publication No. 2006/0014903 discloses a thermoplastic vulcanizate composition disposed about a tensile layer. The thermoplastic vulcanizate composition includes a nucleating agent. The thermoplastic vulcanizate composition has a wall thickness of at least 5 mm. However, the compositions are deficient in abrasion and permeability properties. WO2003/083344 teaches the use of a thermoplastic elastomer polymer for producing the external sheath or the intermediate sheath of flexible subsea pipes. Such thermoplastic vulcanizate compositions are deficient in abrasion performance. Therefore, there is a need for developing new thermoplastic vulcanizate composition with excellent permeability and/or abrasion resistance for providing a superior polymeric material for use in flexible pipes for offshore oil production.

### SUMMARY

Certain embodiments are directed to a flexible pipe for transporting fluids in hydrocarbon production. The flexible pipe includes at least one layer comprised of a thermoplastic vulcanizate (TPV) composition. The TPV composition includes a thermoplastic polyolefin and a rubber phase that is dispersed and at least partially crosslinked. In one embodiment, the TPV composition further includes a cyclic olefin copolymer present in a range from 0.1 wt % to 30 wt % based upon a total weight of the TPV composition. In another embodiment, the TPV composition further includes a hydrocarbon resin present in a range from 0.1 wt % to 30 wt % based upon a total weight of the TPV composition. In yet another embodiment, the TPV composition further includes a slip agent present in a range from 0.1 wt % to 30 wt % based upon a total weight of the TPV composition. In still another embodiment, the TPV composition further includes a silicon hydride reducing agent compound with at least two Si—H groups. In still yet another embodiment, the TPV composition further includes a polyolefin based compatibilizer. In one embodiment, the TPV composition has an abrasion resistance of 75 mg/1000 cycle or less. In another embodiment, the TPV composition has a CO₂ gas permeability greater than 10 barrers.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates various flexible structures suitable for transporting fluids.

FIG. 2 is a schematic diagram of certain embodiments of a multiple layer flexible pipe.

FIG. 3 is a schematic diagram of certain embodiments of a thermoplastic composite pipe.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Each of the inventions will now be described in greater detail below, including specific embodiments, versions and examples, but the inventions are not limited to these embodiments, versions or examples, which are included to enable a person having ordinary skill in the art to make and use the inventions, when the information in this patent is combined with available information and technology.

Various terms as used herein are defined below. To the extent a term used in a claim is not defined below, it should be given the broadest definition persons in the pertinent art have given that term as reflected in one or more printed publications or issued patents.

The term “thermoplastic vulcanizate composition” (also referred to as simply thermoplastic vulcanizate or TPV) is broadly defined as any material that includes a dispersed, at least partially vulcanized, rubber component; a thermoplastic component; and an additive oil. A TPV material may further include other ingredients, other additives, or both.

The term “vulcanizate” means a composition that includes some component (e.g., rubber component) that has been vulcanized. The term “vulcanized” is defined herein in its broadest sense, as reflected in any issued patent, printed publication, or dictionary, and refers in general to the state of a composition after all or a portion of the composition (e.g., crosslinkable rubber) has been subjected to some degree or amount of vulcanization. Accordingly, the term encompasses both partial and total vulcanization. A preferred type of vulcanization is “dynamic vulcanization,” discussed below, which also produces a “vulcanizate.” Also, in at least one specific embodiment, the term vulcanized refers to more than insubstantial vulcanization, e.g., curing (crosslinking) that results in a measurable change in pertinent properties, e.g., a change in the melt flow index (MFI) of the composition by 10% or more (according to any ASTM-1238 procedure). In at least that context, the term vulcanization encompasses any form of curing (crosslinking), both thermal and chemical, that can be utilized in dynamic vulcanization.

The term “dynamic vulcanization” means vulcanization or curing of a curable rubber blended with a thermoplastic resin under conditions of shear at temperatures sufficient to plasticize the mixture. In at least one embodiment, the rubber is simultaneously crosslinked and dispersed as micro-sized particles within the thermoplastic component. Depending on the degree of cure, the rubber to thermoplastic component ratio, compatibility of rubber and thermoplastic component, the kneader/mixer/extruder type and the intensity of mixing (shear rate/shear stress), other morphologies, such as co-continuous rubber phases in the plastic matrix, are possible.

The term “partially vulcanized” rubber means when more than 5 weight percent (wt %) of the crosslinkable rubber is extractable in boiling xylene, subsequent to vulcanization (preferably dynamic vulcanization), e.g., crosslinking of the rubber phase of the thermoplastic vulcanizate. For example, less than 5 wt %, or less than 20 wt %, or less than 30 wt %, or less than 50 wt % of the crosslinkable rubber may be extractable from the specimen of the thermoplastic vulcanizate in boiling xylene. The percentage of extractable rubber can be determined by the technique set forth in U.S. Pat. No. 4,311,628, and the portions of that patent referring to that technique are incorporated herein by reference for U.S. patent practice.

The term “fully vulcanized” (or fully cured or fully crosslinked) rubber means when less than 5 weight percent (wt %) of the crosslinkable rubber is extractable in boiling xylene or cyclohexane, Subsequent to vulcanization (preferably dynamic vulcanization), e.g., crosslinking of the rubber phase of the thermoplastic vulcanizate. Preferably, less than 4 wt % or less, or 3 wt % or less, or 2 wt % or less, or 1 wt % or less of the crosslinkable rubber is extractable in boiling xylene or cyclohexane.

The term “flexible pipes” means flexible pipes and umbilicals, as well as flexible pipes combining the functions of flexible pipes and umbilicals, for use in off-shore/subsea or on-shore applications.

The present disclosure relates to thermoplastic vulcanizate (TPV) compositions that include a thermoplastic polyolefin matrix and a rubber having one or more of the following characteristics: excellent fatigue resistance, good tensile properties, good fabricability, good processability, good abrasion resistance, good creep resistance and/or high gas permeability. In certain embodiments, TPV compositions further include a cyclic olefin copolymer (COC) with surprisingly increased gas permeability compared to similar TPV compositions. In certain embodiments, TPV compositions further include a hydrocarbon resin with surprisingly increased gas permeability compare to similar TPV compositions. In certain embodiments, TPV compositions further include a polyolefin compatibilizer, preferably block copolymer, with excellent processability and tensile properties compare to similar TPV compositions. In certain embodiments, TPV compositions employ a low molecular weight ester based plasticizer for improving low temperature fatigue performance.

It has now been found unexpectedly that certain specific thermoplastic vulcanizate (TPV) compositions exhibit excellent properties for use as the one or more layers of a multiple layer flexible pipe, such as an external protective layer and the thermal insulating layer of flexible conduits for transporting fluids in hydrocarbon production. TPV compositions are used in forming one or more layers of a flexible pipe, tubing, hose, or flexible structure, such as flexible pipes and flexible umbilicals used in transporting fluids in petroleum production. Such articles may be formed by extrusion, calendaring, molding (e.g., injection or compression or blow molding), or other suitable thermoplastic elastomer processing techniques. In certain embodiments, a flexible pipe comprised of the present TPV compositions with good gas permeability has higher reliability since acid gases trapped within the interior of the flexible pipe may permeate out of the flexible pipe due to the good gas permeability.

Certain embodiments are directed to TPV compositions including a slip agent to provide higher abrasion resistance compared to similar TPV compositions. Certain embodiments are directed to TPV compositions including a hydrosilation cure agent, without slip agents, providing higher abrasion resistance compared to similar TPV compositions. In certain embodiments, the TPV compositions having high abrasion resistance are used in forming one or more layers of a multiple layer flexible pipe transporting fluids in petroleum production.

A thermoplastic vulcanizate (TPV) composition and articles made from the same are provided. In one embodiment, the TPV composition includes a dispersed, at least partially vulcanized rubber component; an unvulcanized or non-crosslinked thermoplastic component; a cyclic olefin copolymer or a hydrocarbon resin in a weight percent in a range from 0.1% to 30%. In another embodiment, the TPV composition includes a thermoplastic polyolefin; a rubber phase that is dispersed and is at least partially crosslinked; and a slip agent from 0.1 wt % to 30 wt %. In yet another embodiment, the TPV compositions includes the TPV composition a thermoplastic polyolefin; a rubber phase that is dispersed and at least partially crosslinked; and a polymethylhydrosiloxane based reducing agent with at least two —Si—H groups. In still yet another embodiment, the TPV composition includes a thermoplastic polyolefin; a rubber phase that is dispersed and at least partially crosslinked; and a polyolefin based compatibilizer, preferably diblock polymer based compatibilizer. In certain embodiments, the TPV compositions further include a Shore A Hardness of at least 60 and a Shore D Hardness less than 60. In certain embodiments, the thermoplastic component of the TPV compositions is unvulcanized or non-crosslinked. In one embodiment, a multiple layer flexible pipe includes at least one layer comprising a thermoplastic vulcanizate (TPV) composition having a CO₂ gas permeability of 10 barrers or more.

Certain embodiments are directed to TPV compositions including a thermoplastic polyolefin, a crosslinked rubber, a filler, a processing oil, a curing system, and optionally a slip agent. In certain embodiments, such TPV compositions further include a cyclic olefin copolymer or a hydrocarbon resin. In certain embodiments, such TPV compositions further include a polyolefin based compatibilizer. In certain embodiments, such TPV compositions further include a processing oil.

Unless otherwise indicated, a “composition” includes components of the composition and/or reaction products of two or more components of the composition.

In one or more embodiments, the TPV compositions have a Shore-A hardness of greater than 60, greater than 70, or greater than 80. The TPV compositions also have a Shore-D hardness of less than 60, less than 50, less than 40, or less than 30. In one or more embodiments, the Shore-A hardness may range from a low of 60, 65, or 70 to a high of 75, 80, or 90. In one or more embodiments, the Shore-D hardness may range from a low of 5, 10, or 15 to a high of 40, 45, or 50 or 60. These Shore hardness values are measured according to ASTM D-2240.

Surprisingly, these hardness values are achieved without sacrificing other important mechanical properties, and also without the need to add amounts of oil that cause oil seepage. Also, surprising is that these Shore-A hardness and Shore-D hardness values are achieved without sacrificing ease of processability. For examples, these TPV compositions have a tensile strength at yield measured in accordance with ISO 37 greater than 5 MPA or more, such as 9 MPa or more. For example, in certain embodiment, these TPV composition have a tensile strength at yield in a range from 10 to 30 MPa, such as in a range from 11 to 16 MPa. These TPV compositions also have a tensile strain at yield measured in accordance with ISO 37, ranging from a low of 5%, 15%, or 25% to a high of 100%, or 200%. These TPV compositions also have a creep strain, measured at 23° C. at a stress of 4 MPa, of 100% or less, such as 40% or less, such as in a range from 0.5% to 30%, or such as in a range from 1% to 30%.

### Thermoplastic Polyolefin

Certain embodiments of a thermoplastic polyolefin of TPV compositions comprise a propylene-based thermoplastic polymer, an ethylene-based thermoplastic polymer, or other suitable polyolefin-based thermoplastic polymers. The major component of such propylene-based, ethylene-based, or other suitable polyolefin-based polymers may be homopolymers, random copolymers, impact copolymers, or combination thereof. In certain embodiments the thermoplastic polyolefin matrix of the TPV composition is a blend of two different thermoplastic polyolefins (e.g., polypropylene and polyethylene).

### Propylene-Based Thermoplastic Polymer

Propylene-based thermoplastic polymers include solid, such as high-molecular weight plastic resins, that primarily comprise units deriving from the polymerization of propylene. In some embodiments, at least 75%, in other embodiments at least 90%, in other embodiments at least 95%, and in other embodiments at least 99% of the units of the propylene-based polymer derive from the polymerization of propylene. In particular embodiments, these polymers include homopolymers of propylene.

In certain embodiments, the propylene-based thermoplastic polymers include isotatic polypropylene. For example, the isotatic polypropylene may have an isotatic index of greater than 85% or greater than 90%.

In some embodiments, the propylene-based polymers may also include units deriving from the polymerization of ethylene and/or α-olefins such as 1-butene, 1-hexene, 1-octene, 2-methyl-1-propene, 3-methyl-1-pentene, 4-methyl-1-pentene, 5-methyl-1-hexene, and mixtures thereof.

In some embodiments, the propylene-based polymer includes one, more, or all of the following characteristics:

1) The propylene-based polymers may include semi-crystalline polymers. In some embodiments, these polymers may be characterized by a crystallinity of at least 25% or more (such as about 55% or more, such as about 65% or more, such as about 70% or more). Crystallinity may be determined by dividing the heat of fusion (Hf) of a sample by the heat of fusion of a 100% crystalline polymer, which is assumed to be 209 joules/gram for polypropylene.

2) A Hf that is about 52.3 J/g or more (such as about 100 J/g or more, such as about 125 J/g or more, such as about 140 J/g or more).

3) A weight average molecular weight (Mw) that is between about 50,000 g/mol and about 2,000,000 g/mol, such as between about 100,000 g/mol and about 1,000,000 g/mol, between about 100,000 g/mol and about 600,000 g/mol, or between about 400,000 g/mol and about 800,000 g/mol, as measured by GPC with polystyrene standards.

4) A number average molecular weight (Mn) that is between about 25,000 g/mol and about 1,000,000 g/mol, such as between about 50,000 g/mol and about 300,000 g/mol, as measured by GPC with polystyrene standards.

5) A Z-average molecular weight (Mz) that is between about 70,000 g/mol and about 5,000,000 g/mol, such as between about 100,000 g/mol and about 2,000,000 gmol or between about 300,000 g/mol and about 1,000,000 g/mol, as measured by GPC with polystyrene standards.

6) A melt mass flow rate (MFR) (ASTM D1238, 2.16 kg weight @ 230° C.) that is between about 0.1 g/10 min and about 50 g/10 min, such as between about 0.5 g/10 min and about 5 g/10 min, such as between about 0.5 g/10 min and about 3 g/10 min.

7) A melt temperature (Tₘ) that is from about 110° C. to about 170° C., such as from about 140° C. to about 168° C., or from about 160° C. to about 165° C.

8) A glass transition temperature (T_{g}) that is from about −50° C. to about 10° C., such as from about −30° C. to about 5° C., or from about −20° C. to about 2° C.

9) A crystallization temperature (T_{c}) that is about 75° C. or more, such as about 95° C. or more, such as about 100° C. or more, about 105° C. or more, or between about 105° C. and about 130° C.

The propylene-based polymers may be synthesized by using an appropriate polymerization technique known in the art such as the conventional Ziegler-Natta type polymerizations, and catalysis employing single-site organometallic catalysts including metallocene and post-metallocene catalysts.

The thermoplastic component or thermoplastic phase of the thermoplastic vulcanizate compositions can further include a high viscosity, long-chain branched polyolefin.

In one or more embodiments, the high viscosity, long-chain branched polyolefin is characterized by a melt flow rate of less than 10 dg/min, a weight average molecular weight (M) in excess of 300,000, a Z-average molecular weight (Mz) in excess of 700,000, an M_{w}/Mₙ in excess of 4.0, and an M_{w}/Mₙ in excess of 2.5.

In one or more embodiments, the high viscosity, long-chain branched polyolefins may be characterized by a melt flow rate that is less than about 8 dg/min, in other embodiments less than 5 dg/min, in other embodiments less than 2, and in other embodiments less than 1 dg/min, as determined by ASTM D-1238 at 230° C. and 2.16 kg load.

In one or more embodiments, the high viscosity, long-chain branched polyolefins can be characterized by a weight average molecular weight (M_{w}) in excess of 350,000, in other embodiments in excess of 375,000, and in other embodiments in excess of 400,000. These high viscosity, long-chain branched polyolefins may also be characterized by an M_{w} that is less than 600,000, in other embodiments less than 500,000, and in other embodiments less than 450,000.

In one or more embodiments, the high viscosity, long-chain branched polyolefins may be characterized by a Z-average molecular weight (M_{z}) that is in excess of 800, 000, in other embodiments in excess of 1,000,000, and in other embodiments in excess of 1,100,000. These polyolefins may also be characterized by a M_{z} that is less than 2,000,000, in other embodiments less than 1,500,000, in other embodiments less than 1,300,000.

In one or more embodiments, the high viscosity, long-chain branched polyolefin may be characterized by a number average molecular weight (Mₙ) that is in excess of 40,000, in other embodiments in excess of 50,000, and in other embodiments in excess of 60,000. These polyolefins may be characterized by a Mₙ that is less than 200,000, in other embodiments less than 150,000, and in other embodiments less than 120,000. The molecular weight refers to Mₙ, M_{w}, and M_{z} as determined by gel permeation chromatography with polystyrene and/or polyethylene standards with the polymer dissolved in 1,2,4-trichlorobenzene at 145° C. Similar methods are disclosed in U.S. Pat. No. 4,540,753, which is incorporated herein by reference for U.S. patent practice.

In one or more embodiments, the high viscosity, long-chain branched polyolefins are characterized by M_{w}/Mₙ that is in excess of 4.5, in other embodiments in excess of 5.0, and in other embodiments in excess of 5.5. In one or more embodiments, the high viscosity, long-chain branched polyolefins may be characterized by an M_{w}/Mₙ in excess of 2.7, in other embodiments in excess of 3.0, and in other embodiments in excess of 3.3.

In one or more embodiments, the high viscosity, long-chain branched polyolefins may also be characterized by a viscosity average branching index of less than 0.9, in other embodiments less than 0.7, and in other embodiments less than 0.5.

The branching index, gN, at a given molecular weight is determined according to the formula g′=[η]_{branched}/[η]ₗᵢₙₑₐᵣ, where [n]_{branched} is the viscosity of the branched polymer at a given molecular weight slice, i, and [η]ₗᵢₙₑₐᵣ is the viscosity of the known linear reference polymer at the given molecular weight slice.

$${〈 {g}^{′} 〉}_{vis} = \frac{{\sum }_{i = 1}^{N} {{C}_{i} [ η ]}_{i}}{{\sum }_{i = 1}^{N} {C}_{i} [ {KM}_{i}^{α} ]}$$

where Mi is the molecular weight of the polymer, m, is the intrinsic viscosity of the branched polymer at molecular weight Mi, Ci, is the concentration of the polymer at molecular weight Mi, and K and α. are measured constants from a linear polymer as described by Paul J. Flory at page 310 of PRINCIPLES OF POLYMER CHEMISTRY (1953), and the summation is over all the slices in the distribution. The <g′>ᵥᵢₛ values are obtained by gel permeation chromatography (GPC) while the polymer is in dilute solution within 1.2.4 trichlorobenzene. The GPC is equipped with triple detectors: differential refractive index (DRI), light scattering, and viscosity. The DRI is calibrated with both polystyrene and low molecular weight polyethylene standards, the light scattering detector with a series of polymers of known molecular weight, and the differential viscometer with a series of polymers of known intrinsic viscosities.

In one or more embodiments, the high viscosity, long-chain branched polyolefins employed in this present TPV compositions are prepared by converting solid, high molecular weight, linear, propylene polymer material with irradiating energy as disclosed in U.S. Pat. No. 5,414,027, which is incorporated herein by reference for U.S. patent practice. Other techniques include treatment of linear polymer with heat and peroxide as disclosed in U.S. Pat. No. 5,047,485, which is incorporated herein by reference for U.S. patent practice. Other useful high viscosity, long-chain branched polyolefins are disclosed in U.S. Pat. Nos. 4,916,198, 5,047,446, 5,570.595, and European Publication Nos. EP 0 190 889, EP 0 384 431, EP 0 351 866, and EP 0 634 441, which are incorporated herein by reference for U.S. patent practice.

Examples of propylene-based thermoplastic polymers useful for certain embodiments of the present TPV compositions include ExxonMobil™ PP5341 (available from ExxonMobil of Houston, Tex.); Achieve™ PP6282NE1 (available from ExxonMobil of Houston, Tex.); Braskem™ F008F (a polypropylene homopolymer having a melt flow rate of 0.8 g/10 min available from Braskem of Philadelphia, Pa.); polypropylene resins with broad molecular weight distribution as described in U.S. Pat. Nos. 9,453,093 and 9,464,178; other polypropylene resins described in U.S. Pat. Pub. Nos. US2018/0016414 and US2018/0051160 (for example, PDH025 with a melt flow rate of 2.6 g/10 min); Waymax MFX6 (available from Japan Polypropylene Corp. of Tokyo Japan); Borealis Daploy™ WB140 (available from Borealis AG of Vienna, Austria); Braskem Ampleo 1025MA and Braskem Ampleo 1020GA (available from Braskem of Philadelphia, Pa.); and other suitable polypropylenes.

### Ethylene-Based Thermoplastic Polymer

Ethylene-based thermoplastic polymers include those solid, such as high-molecular weight plastic resins, that primarily comprise units deriving from the polymerization of ethylene. In some embodiments, at least 90%, in other embodiments at least 95%, and in other embodiments at least 99% of the units of the ethylene-based polymer derive from the polymerization of ethylene. In particular embodiments, these polymers include homopolymers of ethylene.

In some embodiments, the ethylene-based polymers may also include units deriving from the polymerization of α-olefins such as propylene, 1-butene, 1-hexene, 1-octene, 2-methyl-1-propene, 3-methyl-1-pentene, 4-methyl-1-pentene, 5-methyl-1-hexene, and mixtures thereof.

In some embodiments, the ethylene-based polymer includes one, more, or all of the following characteristics:

1) A melt index (MI) (ASTM D-1238, 2.16 kg@190° C.) that is from about 0.1 dg/min to about 1,000 dg/min, such as from about 1.0 dg/min to about 200 dg/min or from about 7.0 dg/min to about 20.0 dg/min.

2) A melt temperature (Tₘ) that is from about 140° C. to about 90° C., such as from about 135° C. to about 125° C. or from about 130° C. to about 120° C.).

3) A density greater than 0.90 g/cm³.

The ethylene-based polymers may be synthesized by using an appropriate polymerization technique known in the art such as the conventional Ziegler-Natta type polymerizations, and catalysis employing single-site organometallic catalysts including metallocene catalysts. Ethylene-based polymers are commercially available. For example, polyethylene is commercially available under the trade name ExxonMobil™ Polyethylene (available from ExxonMobil of Houston, Tex.). Ethylene-based copolymers are commercially available under the trade name ExxonMobil™ Polyethylene (available from ExxonMobil of Houston, Tex.), which include metallocene produced linear low density polyethylene including Exceed™, Enable™, and Exceed™ XP. Examples of ethylene-based thermoplastic polymers useful for certain embodiments of the present TPV compositions described herein include ExxonMobil HD7800P, ExxonMobil HD6706.17, ExxonMobil HD7960.13, ExxonMobil HD9830, ExxonMobil AD60-007, Exceed XP 8318ML, Exceed™ XP 6056ML, Exceed 1018HA, Enable™ 2010 Series, Enable™ 2305 Series, and ExxonMobil™ LLDPE LL (e.g. 1001, 1002YB, 3003 Series), ail available from ExxonMobil of Houston, Tex. Additional examples of ethylene-based thermoplastic polymers useful for certain embodiments of the present TPV compositions described herein include Innate™ ST50 and Dowlex™, available from The Dow Chemical Company of Midland, Mich.

In some embodiments, the PE may be any crystalline PE, preferably a high density PE (“HDPE”) which has a density (sp. gr.) of about 0.940 to about 0.965 g/cc and a MI in the range from 0.1 to 20. HDPE is commercially available in different forms, each relatively high polydispersity index (Mw/Mn) in the range from about 20 to about 40. In some embodiments, the PE is a bimodal high density PE such as ExxonMobil HD 7800P is a high-density polyethylene having a melt flow index of 0.25 g/10 min. ExxonMobil HD 7800P is available from ExxonMobil of Houston, Tex.

In one or more embodiments, the thermoplastic phase includes a polyethylene resin. In one or more embodiments, this polyethylene resin is a polyethylene homopolymer. In one or more embodiments, the polyethylene may be characterized by having a weight average molecular weight of from about 100 to 250 kg/mole, or from about 110 to 220 kg/mole, or from about 150 to 200 kg/mole. This polyethylene may be characterized by having a polydispersity index (Mw/Mn) that is less than 12, or less than 11, or less than 10, or less than 9.

The PE may be present in the thermoplastic vulcanizate composition as a blend with PP, such as isotatic polypropylene, in an amount of greater than 5 wt %, or greater than 7 wt %, or greater than 10 wt % based on the weight of the thermoplastic vulcanizate composition. The PE may be present in the thermoplastic vulcanizate composition in an amount from 5 to 25 wt % if present as a blend component with PP, such as isotactic polypropylene.

### Rubber

Rubbers include olefinic elastomeric polymers, nitrile rubber, butyl rubber, alkyl acrylate copolymers (ACM), other suitable rubbers, mixtures, and blends thereof. In certain embodiments, olefinic elastomeric polymers include ethylene-based elastomers such as ethylene-propylene rubber. In certain embodiments, the rubbers that may be employed include those polymers that are capable of being cured or crosslinked by a phenolic cure, by a hydrosilation cure (e.g., silane-containing curative), by moisture cure via silane grafting, by a peroxide curative, or by an azide curative. Reference to a rubber may include blends and mixtures of more than one rubber.

### Ethylene-Propylene Rubber

The term ethylene-propylene rubber refers to rubbery polymers polymerized from ethylene, at least one other α-olefin monomer, and at least one diene monomer (for example. an ethylene-propylene-diene (EPDM) terpolymer). The α-olefins may include propylene, 1-butene, 1-hexene, 4-methyl-1-pentene, 1-octene, 1-decene, or combinations thereof. In certain embodiments, the α-olefins include propylene, 1-hexene, 1-octene or combinations thereof. The diene monomers include 5-ethylidene-2-norbornene (ENB), 5-vinyl-2-norbornene (VNB), divinylbenzene, 1,4-hexadiene, 5-methylene-2-norbornene, 1,6-octadiene, 5-methyl-1,4-hexadiene, 3,7-dimethyl-1,6-octadiene, 1,3-cyclopentadiene, 1,4-cyclohexadiene, dicyclopentadiene, or a combination thereof. In certain embodiments, the diene monomers include sterically unhindered non-conjugated C-C double bonds such as ENB or VNB.

The ethylene-propylene rubber may include diene in a range from about 1 weight percent (wt %) to about 15 wt %, such as from about 3 wt % to about 15 wt %, from about 5 wt % to about 12 wt %, or from about 7 wt % to about 11 wt %, based on the total weight of the ethylene-propylene rubber.

In certain embodiments, the ethylene-propylene rubber includes one, more, or all of the following characteristics:

1) An ethylene-derived content that is in a range from about 10 wt % to about 99.9 wt %, such as from about 10 wt % to about 90 wt %, from 12 wt % to about 90 wt %, from about 15 wt % to about 90 wt %, from about 20 wt % to about 80 wt %, from about 40 wt % to about 70 wt %, from about 50 wt % to about 70 wt %, from about 55 wt % to about 65 wt %, or from about 60 wt % and about 65 wt %, based on the total weight of the ethylene-propylene rubber. In some embodiments, the ethylene-derived content is a range from about 40 wt % to about 85 wt %, such as from about 40 wt % to about 85 wt %, based on the total weight of the rubber.

2) A diene-derived content that is in a range from about 0.1 wt % to about to about 15 wt %, such as from about 0.1 wt % to about 5 wt %, from about 0.2 wt % to about 10 wt %, from about 2 wt % to about 8 wt %, from about 4 wt % to about 12 wt %, or from about 4 wt % to about 9 wt %, based on the total weight of the rubber. In some embodiments, the diene-derived content is from about 3 wt % to about 15 wt % based on the total weight of the rubber.

3) The balance of the ethylene-propylene rubber includes α-olefin-derived content, such as C₂ to C₄₀ olefins, C₃ to C₂₀ olefins, C₃ to C₁₀ olefins, or propylene.

4) A weight average molecular weight (Mw) that is in a range of about 100,000 g/mol or more, such as about 200,000 g/mol or more, about 400,000 g/mol or more, or about 600,000 g/mol or more. In these or other embodiments, the Mw is in a range of about 1,200,000 g/mol or less, such as about 1,000,000 g/mol or less, about 900,000 g/mol or less, or about 800,000 g/mol or less. In these or other embodiments, the Mw can in a range from about 500,000 g/mol to about 3,000,000 g/mol, such as from about 500,000 g/mol to about 2,000,000, from about 500,000 g/mol to about 1,500,000 g/mol, from about 600,000 g/mol to about 1,200,000 g/mol, or from about 600,000 g/mol to about 1,000,000 g/mol.

5) A number average molecular weight (Mn) that is in a range from about 20,000 g/mol or more, such as about 60,000 g/mol or more, about 100,000 g/mol or more, or about 150,000 g/mol or more. In these or other embodiments, the Mn is in a range from about 500,000 g/mol or less, such as about 400,000 g/mol or less, about 300,000 g/mol or less, or about 250,000 g/mol or less.

6) A Z-average molecular weight (Mz) that is in a range from about 10,000 g/mol to about 7,000,000 g/mol, such as from about 50,000 g/mol to about 3,000,000 g/mol, from about 70,000 g/mol to about 2,000,000 g/mol, from about 75,000 g/mol to about 1,500,000 g/mol, from about 80,000 g/mol to about 700,000 g/mol, or from about 100,000 g/mol to about 500,000 g/mol.

7) A polydispersity index (Mw/Mn; PDI) that is in a range from about 1 to about 10, such as from about 1 to about 5, from about 1 to about 4, from about 2 to about 4, from about 1 to about 3, from about 1.8 to about 3, from about 1 to about 2, or from about 1 to 2.5.

8) A dry Mooney viscosity (ML(1+4) at 125° C.) per ASTM D-1646, that is in a range from about 10 MU to about 500 MU, such as from about 50 MU to about 450 MU. In these or other embodiments, the Mooney viscosity is 250 MU or more, such as 350 MU or more.

9) A glass transition temperature (T_{g}), as determined by Differential Scanning Calorimetry (DSC) according to ASTM E 1356, that is in a range from about −20° C. or less, such as about −30° C. or less or about −50° C. or less. In some embodiments, T_{g} is in a range from about −60° C. and about −20° C.

The ethylene-propylene rubber may be manufactured or synthesized by using a variety of techniques. For example, these polymers can be synthesized by employing solution, slurry, or gas phase polymerization techniques of combination thereof that employ various catalyst systems including Ziegler-Natta systems including vanadium based catalysts and take place in various phases such as solution, slurry, or gas phase. Exemplary catalysts include single-site catalysts including constrained geometry catalysts involving Group IV-VI metallocenes. In some embodiments, the EPDMs can be produced via a conventional Zeigler-Natta catalysts using a slurry process, especially those including Vanadium compounds, as disclosed in U.S. Pat. No. 5,783,645, as well as metallocene catalysts, which are also disclosed in U.S. Pat. No. 5,756,416. Other catalysts systems such as the Brookhart catalyst system may also be employed. Optionally, such EPDMs can be prepared using the above catalyst systems in a solution process.

Examples of ethylene-propylene rubbers useful in certain embodiments of the present TPV compositions include ExxonMobil EPDM(E)-1, ExxonMobil EPDM(V)-1, ExxonMobil EPDM(E)-2, ExxonMobil EPDM(E)-2, ExxonMobil EPDM(V)-2, Keltan 5469Q, Keltan 4969Q, Keltan 5469, Keltan 4869, or other suitable elastomeric polymers. EPDM(E)-1 is an ethylene-propylene-ethylidene-norbornene rubber with a Mooney ML viscosity (1+4, 125° C.) of 50. EPDM(E)-1 contains 64 wt % ethylene, 4.2 wt % ethylidenenorbornene, and 75 phr extender oil. EPDM(E)-1 is available from ExxonMobil of Houston, Tex. EPDM(V)-1 is an ethylene-propylene-ethylidene-norbornene rubber with a Mooney ML viscosity (1+4, 125° C.) of 52. EPDM(V)-1 contains 62 wt % ethylene, 0.7 wt % vinyl norbornene, and 100 phr extender oil. EPDM(V)-1 is available from ExxonMobil of Houston, Tex. EPDM(E)-2 is an ethylene-propylene-ethylidene-norbornene rubber with a Mooney ML viscosity (1+4, 125° C.) of 147. EPDM(E)-2 contains 54 wt % ethylene, 10 wt % ethylidenenorbornene, and 0 phr extender oil. EPDM(E)-2 is available from ExxonMobil of Houston, Tex. EPDM(V)-2 is an ethylene-propylene-ethylidene-norbornene rubber with a Mooney ML viscosity (1+4, 125° C.) of 25. EPDM(V)-2 contains 77 wt % ethylene, 0.9 wt % vinyl norbornene, and 0 phr extender oil. EPDM(V)-2 is available from ExxonMobil of Houston, Tex. Keltan 5469Q is an ethylene-propylene-ethylidene-norbornene rubber with a Mooney ML viscosity (1+4, 125° C.) of 48. Keltan 5469Q contains 61 wt % Ethylene, 4 wt % ethylidenenorbornene, and 100 phr extender oil. Keltan 5469Q is available from Arlanxeo Performance Elastomers of Orange, Tex. Keltan 4969Q is an ethylene-propylene-ethylidene-norbornene rubber with a Mooney ML viscosity (1+4, 125° C.) of 37. Keltan 4969Q contains 68 wt % ethylene, 9.4 wt % ethylidenenorbornene, and 100 phr extender oil. Keltan 4969Q is available from Arlanxeo Performance Elastomers of Orange, Tex. Keltan 5469 is an ethylene-propylene-ethylidene-norbornene rubber with a Mooney ML viscosity (1+4, 125° C.) of 52. Keltan 5469 contains 63.2 wt % Ethylene, 4.5 wt % ethylidenenorbornene, and 100 phr extender oil. Keltan 5469 is available from Arlanxeo Performance Elastomers of Orange, Tex. Keltan 4869 is an ethylene-propylene-diene rubber. Keltan 4869 is available from Arlanxeo Performance Elastomers of Orange, Tex.

### Other Rubbers

In certain embodiments, the rubber is a non-halogenated elastomer including repeating units derived from at least one C₄ to C₇ isomonoolefin monomer and at least 3.5 mol % of repeating units derived from at least one C₄ to C₇ multiolefin monomer.

In certain embodiment, the rubber is a nitrile rubber, such as an acrylonitrile copolymer rubber. Suitable nitrile rubbers comprise rubbery polymers of 1,3-butadiene and acrylonitrile. Certain nitrile rubbers comprise polymers of 1,3-butadiene and about 20 to 50 weight percent acrylonitrile. Certain nitrile rubbers include “solid” rubbers having a weight average molecular weight (Mw) of at least 50,000, and preferably from about 100,000 to 1,000,000. Commercially available nitrile rubbers suitable for the practice of the present TPV compositions are described in Rubber World Blue Book, 1980 Edition, Materials and Compounding Ingredients for Rubber, pages 386-406.

The term butyl rubber refers both halogenated and un-halogenated copolymers of isobutylene. Examples of copolymers of isobutylene include copolymers of isobutylene and isoprene, also known as isobutylene isoprene rubber (IIR), and copolymers of isobutylene and C₁₋₄ alkyl styrene, such as paramethyl styrene. Examples of halogenated butyl rubber include bromobutyl rubber and brominated copolymers of isobutylene and paramethyl styrene available under the trade name BIMSM™ available from ExxonMobil of Houston, Tex.

In one embodiment, where butyl rubber includes the isobutylene-isoprene copolymer, the copolymer may include isoprene in a range from about 0.5 wt % to about 30 wt %, such from about 0.8 wt % to about 5 wt %, based on the entire weight of the copolymer with the remainder being isobutylene.

In another embodiment, where butyl rubber includes isobutylene-paramethyl styrene copolymer, the copolymer may include paramethyl styrene in a range from about 0.5 wt % to about 25 wt %, such as from about 2 wt % to about 20 wt %, based on the entire weight of the copolymer with the remainder being isobutylene. In one embodiment, isobutylene-paramethyl styrene copolymers can be halogenated, such as with bromine. These halogenated copolymers can be halogenated in a range from about 0 wt % to about 10 wt %, such as from about 0.3 wt % to about 7 wt %.

Butyl rubber can be obtained from a number of commercial sources as disclosed in the Rubber World Blue Book. For example, both halogenated and un-halogenated copolymers of isobutylene and isoprene are available under the trade name Exxon Butyl™ available from ExxonMobil of Houston, Tex., halogenated and un-halogenated copolymers of isobutylene and paramethyl styrene are available under the trade name EXXPRO™ available from ExxonMobil of Houston, Tex., and star branched butyl rubbers are available under the trade name STAR BRANCHED BUTYL™ available from ExxonMobil of Houston, Tex. Halogenated and non-halogenated terpolymers of isobutylene, isoprene, and divinyl styrene are available under the trade name Polysar Butyl™ available from Bayer of Leverkusen, Germany.

In certain embodiments, the rubber is a blend of EPDM terpolymer and a copolymer of isobutylene and C₁₋₄ alkyl styrene.

### Cyclic Olefin Copolymer (COC) or Hydrocarbon Resin

In certain embodiments, TPV compositions further include a cyclic olefin copolymer (COC) or hydrocarbon resin to increase gas permeability compared to similar TPV compositions.

Examples of COCs comprise copolymers of cyclic monomers, such as norbornene, tetracyclododecene, and other cyclic monomers. In certain embodiments, COCs comprise a copolymer of norbornene and ethylene. COCs may be fully hydrogenated, partially hydrogenated, or un-hydrogenated. COCs may be manufactured or synthesized by using a variety of techniques. For examples, COCs can be obtained by ring opening metathesis polymerization of cyclic monomers. Examples of COCs useful for certain embodiments of the present TPV compositions include TOPAS, APEL, ARTON, and ZEONEX. Topas 5013 is a COC having a melt volume rate of 48 ml/10 min. Topas 5013 is available from TOPAS Advanced Polymers of Frankfurt-Höchst, Germany. Topas 8007 is a COC having a melt volume rate of 32 ml/10 min. Topas 8007 is available from TOPAS Advanced Polymers of Frankfurt-Höchst, Germany. APEL is available from Mitsui Chemical of Tokyo, Japan. ARTON is available from JSR Corporation of Tokyo, Japan. ZEONEX is available from Zeon Corporation of Tokyo Japan.

In certain embodiments, TPV compositions including COCs or hydrocarbon resins surprisingly have high gas permeability since COCs or hydrocarbon resins by itself have high amorphous content. In the present TPV compositions, the COCs or the hydrocarbon resins may be used to break up the crystallinity of the thermoplastic polyolefin matrix so that the thermoplastic vulcanizate composition has high gas permeability.

In certain embodiments, TPV compositions including COCs or hydrocarbon resins have low thermal conductivity. In the present TPV compositions, the COCs or hydrocarbon resins may be used to lower the thermal conductivity of the thermoplastic vulcanizate composition since the COCs by itself have low thermal conductivity.

In certain embodiments, TPV compositions including COCs have high hardness. In the present TPV compositions, the COCs may be used to increase the hardness of the TPV composition since the COCs by itself have high hardness.

In certain embodiments, TPV compositions including COCs have high abrasion resistance. In the present TPV compositions, the COCs may be used to increase the abrasion resistance of the TPV composition since the COCs by itself have high abrasion resistance.

In certain embodiments, the COCs include one, some, or all of the following characteristics:

1) A cyclic monomer content in a range from 30 wt % to 90 wt % based on the total weight of the COC.

2) A glass transition Tg as determined by Differential Scanning Calorimetry (DSC) according to ASTM E 1356 that is in a range from 10° C. to 190° C. when measured at 10° C./min. In some embodiments, Tg is in a range from 60° C. to 160° C.

3) A melt mass flow rate MFR (ASTM D-1238; 2.16 kg @ 230° C.) that is in a range from 1 ml/10 min to 60 ml/10 min at 260° C., 2.16 kg. In some embodiments, the melt flow rate is in a range from 4 ml/10 min to 50 ml/10 min at 260° C., 2.16 kg.

In certain embodiments, the hydrocarbon resins include one or both of the following characteristics:

1) A glass transition Tg as determined by Differential Scanning Calorimetry (DSC) according to ASTM E 1356 that is in a range from 10° C. to 190° C. when measured at 10° C./min. In some embodiments, Tg is in a range from 60° C. to 160° C.

2) A melt mass flow rate MFR (ASTM D-1238; 2.16 kg @ 230° C.) that is in a range from 1 ml/10 min to 60 ml/10 min at 260° C., 2.16 kg. In some embodiments, the melt flow rate is in a range from 4 ml/10 min to 50 ml/10 min at 260° C., 2.16 kg.

### Fillers

Fillers that can be used include reinforcing and non-reinforcing fillers. Examples of suitable fillers that can be utilized include clay, talc, silica, calcium carbonate, titanium dioxide, carbon black, a nucleating agent, mica, wood flour, other suitable organic or inorganic fillers, and blends thereof. One example of fillers useful in certain embodiments of the thermoplastic vulcanizate compositions described herein includes Icecap K Clay. Icecap K Clay is a calcined aluminum silicate filler available from Burgess Pigment Company of Sandersville, Ga.

### Nucleating Agent

The term “nucleating agent” means any additive that produces a nucleation site for thermoplastic crystals to grow from a molten state to a solid, cooled structure. In other words, nucleating agents provide sites for growing thermoplastic crystals upon cooling the thermoplastic from its molten state.

The nucleating agent provides a plurality of nucleating sites for the thermoplastic component to crystallize when cooled. Surprisingly, this plurality of nucleating sites promotes even crystallization within the thermoplastic vulcanizate composition, allowing the composition to crystallize throughout an entire cross section in less time and at higher temperature. This plurality of nucleating site produces a greater amount of smaller crystals within the thermoplastic vulcanizate composition which require less cooling time.

This even cooling distribute enables the formation of extruded articles of the present TPV compositions having a thickness greater than 2 mm, such as greater than 5 mm, greater than 10 mm, and even greater than 15 mm. Extruded articles of the present TPV compositions can have thicknesses greater than 20 mm and still exhibit effective cooling (i.e., cooling from an outer surface of the cross section to an inner surface of the cross section) at extrusion temperatures without sacrificing mechanical strength. Such extrusion temperatures are at or above the melting point of the thermoplastic component. Illustrative nucleating agents include, but are not limited to dibenzylidene sorbitol based compounds, sodium benzoate, sodium phosphate salts, as well as lithium phosphate salts. For example, the nucleating agent may include sodium 2,2′-methylene-bis-(2,6-di-tert-butylphenyl)phosphate which is commercially available from Milliken & Company of Spartanburg, S.C. under the trade name Hyperform™. Another specific nucleating agent is norbornane (bicyclo(2.2.1)heptane carboxylic acid salt, which is commercially available from CIBA Specialty Chemicals of Basel, Switzerland.

### Processing Oils/Plasticizers

Processing oils that can be used include mineral oils (such as Group 1 mineral oils or Group II mineral oils), petroleum-based oils, synthetic oils, low molecular weight aliphatic esters, ether ester, other suitable oils, or a combination thereof. These oils may also be referred to as plasticizers or extenders. Mineral oils may include aromatic, naphthenic, paraffinic, isoparaffinic oils, synthetic oils, and combinations thereof. The mineral oils may be treated or untreated. One example of a mineral oil useful in certain embodiments of the present TPV compositions includes Paramount 6001R available from Chevron Products Company of San Ramon, Calif.

Many additive oils are derived from petroleum fractions, and have particular ASTM designations depending on whether they fall into the class of paraffinic, naphthenic, or aromatic oils. According to the American Petroleum Institute (API) classifications, base stocks are categorized in five groups based on their saturated hydrocarbon content, sulfur level, and viscosity. Group I oils and group II oils are derived from crude oil via processing, such as solvent extraction, solvent or catalytic dewaxing, and hydroisomerization, hydrocracking and isodewaxing, isodewaxing and hydrofinishing. Synthetic oils include alpha olefinic synthetic oils, such as liquid polybutylene. Additive oils derived from coal tar and pine tar can also be used. Examples of such oils include, white oil produced from gas to liquid technology such as Risella™ X 415/420/430 (available from Shell of Houston, Tex.); Primol™ 352, Primol™ 382, Primol™ 542, Marcol™ 82, and Marcol™ 52 (available from ExxonMobil of Houston, Tex.); Drakeol® 34 available from Penreco of Karns City, Pa.; or combinations thereof. Oils described in U.S. Pat. No. 5,936,028, which is incorporated herein by reference for U.S. patent practice, may also be employed.

In some embodiments, synthetic oils include polymers and oligomers of butenes including isobutene, 1-butene, 2-butene, butadiene, and mixtures thereof. In some embodiments, these oligomers can be characterized by a number average molecular weight (Mn) in a range from about 300 g/mol to about 9,000 g/mol, and in other embodiments from about 700 g/mol to about 1,300 g/mol. In some embodiments, these oligomers include isobutenyl mer units. Exemplary synthetic oils include polyisobutylene, poly(isobutylene-co-butene), and mixtures thereof. In some embodiments, synthetic oils may include polylinear α-olefins, poly-branched α-olefins, hydrogenated polyalphaolefins, and mixtures thereof. In some embodiments, the synthetic oils include synthetic polymers or copolymers having a viscosity in a range from about 20 cp or more, such as about 100 cp or more or about 190 cp or more, where the viscosity is measured by a Brookfield viscometer according to ASTM D-4402 at 38° C. In these or other embodiments, the viscosity of these oils can be in a range of about 4,000 cp or less, such as about 1,000 cp or less. Useful synthetic oils can be commercially obtained under the trade names Polybutene™ (available from Soltex of Houston, Tex.), Parapol™ (available from ExxonMobil of Houston, Tex.) and Indopol™ (Ineos of League City, Tex.). Oligomeric copolymers including butadiene are commercially available under the trade name Ricon Resin™ (available from Ricon Resins of Grand Junction, Colo.).

The ordinarily skilled chemist will recognize which type of oil should be used with a particular rubber, and also be able to determine the amount (quantity) of oil. The additive oil can be present in amounts in a range from about 5 to about 300 parts by weight per 100 parts by weight of the blend of the rubber and isotactic polypropylene components. The amount of additive oil may also be expressed as in a range from about 30 to 250 parts, such as from about 70 to 200 parts by weight per 100 parts by weight of the rubber component. Alternatively, the quantity of additive oil can be based on the total rubber content, and defined as the ratio, by weight, of additive oil to total rubber in the TPV, and that amount may in certain cases be the combined amount of processing oil (typically added during processing) and extender oil (typically added after processing). The ratio may range, for example, from about 0 to about 4.0/1. Other ranges, having any of the following lower and upper limits, may also be utilized: a lower limit of 0.4/1, or 0.6/1, or 0.8/1, or 1.0/1, or 1.2/1, or 1.5/1, or 1.8/1, or 2.0/1, or 2.5/1; and an upper limit (which may be combined with any of the foregoing lower limits) of 4.0/1, or 3.8/1, or 3.5/1, or 3.2/1, or 3.0/1, or 2.8/1. Larger amounts of additive oil can be used, although the deficit is often reduced physical strength of the composition, oil weeping, or both.

Polymeric processing additives may also optionally be added. These processing additives may include polymeric or oligomeric resins, such as hydrocarbon resins that have a very high melt flow index. These polymeric resins include both linear and branched molecules that have a melt flow rate that is a range of about 500 dg/min or greater, about 750 dg/min or greater, about 1000 dg/min or greater, about 1200 dg/min or greater, or about 1500 dg/min or greater. Mixtures of various branched or various linear polymeric processing additives, as well as mixtures of both linear and branched polymeric processing additives may be used. Examples of useful linear polymeric processing additives include polypropylene homopolymers. Examples of useful branched polymeric processing additives include diene-modified polypropylene polymers. Thermoplastic vulcanizates that include similar processing additives are disclosed in U.S. Pat. No. 6,451,915, which is incorporated herein by reference for U.S. patent practice.

In some embodiments, the addition of certain low to medium molecular weight (<10,000 g/mol) organic esters and alkyl ether esters to the present TPV compositions dramatically lower the Tg of the polyolefin and rubber components and of the overall composition. The addition of certain low to medium molecular weight (<10,000 g/mol) organic esters and alkyl ether esters improve the low temperature properties, particularly flexibility and strength. It was surprisingly observed that such formulations have enhanced permeability and abrasion resistance. It is believed that these effects are achieved by the partitioning of the ester into both the polyolefin and rubber components of the compositions. Particularly suitable esters include monomeric and oligomeric aliphatic esters having a low molecular weight, such as an average molecular weight in a range from about 2000 or below, such as about 600 or below. In certain aspects, the ester is selected to be compatible, or miscible, with both the polyolefin and rubber components of the compositions, i.e., that the ester mixes with the other components to form a single phase. The esters found to be suitable include monomeric alkyl monoesters, monomeric alkyl diesters, oligomeric alkyl monoesters, oligomeric alkyl diesters, monomeric alkylether monoesters, monomeric alkylether diesters, oligomeric alkylether monoesters, oligomeric alkylether diesters, and mixtures thereof. Polymeric aliphatic esters and aromatic esters were found to be significantly less effective, and phosphate esters were for the most part ineffective.

Examples of esters which have been found satisfactory for use in the present

TPV compositions include diisooctyldodecanedioate, dioctylsebacate, butoxyethyloleate, n-butyloleate, n-butyltallate, isooctyloleate, isooctyltallate, dialkylazelate, diethylhexylsebacate, alkylalkylether diester glutarate, oligomers thereof, and mixtures thereof. Other analogues expected to be useful in the present TPV compositions include alkyl alkylether monoadipates and diadipates, monoalkyl and dialkyl adipates, glutarates, sebacates, azelates, ester derivatives of castor oil or tall oil, and oligomeric monoesters and diesters or monoalkyl and dialkyl ether esters therefrom. Isooctyltallate and n-butyltallate are useful. These esters may be used alone in the compositions, or as mixtures of different esters, or they may be used in combination with conventional hydro carbon oil diluents or processing oils, e.g., paraffin oil. In certain embodiments, the amount of ester plasticizer in the TPV composition is a range from about 0.1 wt % to about 40 wt % based upon a total weight of the TPV composition. In certain embodiments, the amount of ester plasticizer in the TPV composition is in a range of than about 250 phr or less, such as about 175 phr or less. In certain embodiments, the ester plasticizer is isooctyltallate. Such esters are available commercially as Plasthall™ available from Hallstar of Chicago, Ill. In certain embodiments, the ester plasticizer is n-butyl tallate.

Certain embodiments include, hydrocarbon resins produced from petroleum-derived hydrocarbons and monomers of feedstock including tall oil and other polyterpene or resin sources. The terms “hydrocarbon resin” or “resin molecule” are interchangeable as used herein. Hydrocarbon resins are generally derived from petroleum streams, and may be hydrogenated or non-hydrogenated resins. The hydrocarbon resins may be polar or non-polar. “Non-polar” means that the HPA is substantially free of monomers having polar groups. Such hydrocarbon resins may include substituted or unsubstituted units derived from cyclopentadiene homopolymer or copolymers, dicyclopentadiene homopolymer or copolymers, terpene homopolymer or copolymer, pinene homopolymer or copolymers, C₅ fraction homopolymer or copolymer, C₉ fraction homopolymer or copolymers, alpha-methylstyrene homo or copolymers, and combinations thereof. Examples of hydrocarbon resins include aliphatic hydrocarbon resins such as resins resulting from the polymerization of monomers consisting of olefins and diolefins (e.g., ESCOREZ™ and Oppera™ from ExxonMobil Chemical Company, Houston, Tex. or PICCOTAC 1095 from Eastman Chemical Company, Kingsport, Tenn.) and the hydrogenated derivatives thereof: alicyclic petroleum hydrocarbon resins and the hydrogenated derivatives thereof (e.g. ESCOREZ 5300 and 5400 series from ExxonMobil Chemical Company; EASTOTAC resins from Eastman Chemical Company). Other exemplary resins useful in the present TPV compositions include, the hydrogenated cyclic hydrocarbon resins (e.g. REGALREZ and REGALITE resins from Eastman Chemical Company). In some embodiments, the resin has a Ring and Ball (R&B) softening point equal to or greater than 80° C. The Ring and Ball (R&B) softening point can be measured by the method described in ASTM E28, which is incorporated herein by reference. Surprising enhancements in permeability and lower thermal conductivities are observed by incorporating hydrocarbon resins in the present thermoplastic vulcanizate compositions.

### Slip Agent

In certain embodiments, in addition to the rubber, thermoplastic resins, processing oils, and fillers, the present TPV compositions may optionally include a slip agent when the crosslinked rubber is cured with a phenolic or peroxide based cure systems. Slip agents can be defined as class of fillers or additives intended to reduce the coefficient of friction of the TPV composition while also improving the abrasion resistance. Examples of slip agents include siloxane based additives (such as polysiloxanes), ultra-high molecular weight polyethylene, a blend of siloxane based additives (such as polysiloxanes) and ultra-high molecular weight polyethylene, molybdenum disulfide molybdenum disulfide, halogenated and unhalogenated compounds based on aliphatic fatty chains, fluorinated polymers, perfluorinated polymers, graphite, and combinations thereof. The slip agents are selected with a molecular weight suitable for the use in oil, paste, or powder form.

Slip agents useful in the TPV compositions include, but ARE not limited to, fluorinated or perfluorinated polymers, such as Kynar™ (available from Arkema of King of Prussia, Pa.), Dynamar™ (available from 3M of Saint Paul, Minn.), molybdenum disulfide, or compounds based on aliphatic fatty chains, whether halogenated or not, or polysiloxanes. In some embodiments, the slip agents can be of the migratory or non-migratory type, and more preferably of the non-migratory type.

In some embodiments, the polysiloxane comprises a migratory siloxane polymer which is a liquid at standard conditions of pressure and temperature. A suitable polysiloxane is a high molecular weight, essentially linear polydimethyl-siloxane (PDMS). Additionally, the polysiloxane may have a viscosity at room temperature in a range from about 100 to about 100,000 cSt, such as from about 1,000 to about 10,000 cSt, or from about 5,000 cSt to about 10,000 cSt.

In certain embodiments polysiloxane also contains R groups that are selected based on the cure mechanism desired for the composition containing the first polysiloxane. Typically, the cure mechanism is either by means of condensation cure or addition cure, but is generally via an addition cure process. For condensation reactions, two or more R groups per molecule should be hydroxyl or hydrolysable groups such as alkoxy group having up to 3 carbon atoms. For addition reactions, two or more R groups per molecule may be unsaturated organic groups, typically alkenyl or alkynyl groups, preferably having up to 8 carbon atoms. One suitable commercially available material useful as the first polysiloxane is XIAMETER® PMX-200 Silicone Fluid available from Dow Corning Midland, Mich. In certain embodiments, the TPV compositions described herein contain polysiloxane in a range from about 0.2 wt % to about 20 wt %, such as from about 0.5 wt % to about 15 wt % or from about 0.5 wt % to about 10 wt %.

In certain embodiments, polysiloxane, such as polyorganosiloxanes, comprises a non-migratory polysiloxane which is bonded to a thermoplastic material. The polysiloxane is reactively dispersed in a thermoplastic material, which may be any homopolymer or copolymer of ethylene and/or α-olefins such as propylene, 1-butene, 1-hexene, 1-octene, 2-methyl-1-propene, 3-methyl-1-pentene, 4-methyl-1-pentene, 5-methyl-1-hexene, and mixtures thereof. In one embodiment, the thermoplastic material is a polypropylene homopolymer. Suitable methods of reactively bonding a polysiloxane to an organic thermoplastic polymer, such as a polyolefin, are disclosed in International Patent Publication Nos. WO2015/132190 and WO2015/150218, the entire contents of which are incorporated herein by reference for U.S. patent practice.

In some embodiments, the polysiloxane may comprise predominantly D and/or T units and contains some alkenyl functionalities, which assist in the reaction with the polymer matrix. There is a covalent bond between the polysiloxane and the polypropylene. In some embodiments, the reaction product of polysiloxane and the polypropylene has a number average molecular weight in a range from about 0.2 kg/mol to about 100 kg g/mole. The number average molecular weight of the reaction product of the polyorganosiloxane and the polymer matrix is at least 1.1 times, preferably at least 1.3 times, the number average molecular weight of the base polyorganosiloxane. In some embodiments, the second polyorganosiloxane has a gum loading of in a range from about 20 wt % and about 50 wt %.

One example of a slip agent is HMB-0221. HMB-0221 is provided as pelletized concentrate containing reaction products of ultrahigh molecular weight siloxane polymer reactively dispersed in polypropylene homopolymer. HMB-0221 is available from Dow Corning of Midland, Mich. In certain embodiments, the TPV compositions described herein contain a non-migratory polysiloxane in a range from about 0.2 wt % to about 20 wt %, such as from about 0.2 wt % to about 15 wt % or from about 0.2 wt % to about 10 wt %.

In certain embodiments, TPV compositions described herein comprise one or more ultrahigh molecular weight polyethylenes (“UHMWPE”) as the abrasion enhancing additive. The UHMWPE is a polyethylene polymer that comprises primarily ethylene-derived units. In some embodiments, the UHMWPE is a homopolymer of ethylene. In other embodiments, the UHMWPE is a copolymer of ethylene and an α-olefin such as 1-butene, 1-pentene, 1-hexene, 1-octene, 1-decene, 1-dodecene, 4-methyl-1-pentene, or 3-methyl-1-pentene. The UHMWPE has a weight average molecular weight of about 1,500,000 g/mol or greater, about 1,750,000 g/mol or greater, or about 1,850,000 g/mol or greater, or about 1,900,000 g/mol or greater. Examples of UHMWPE include Mipelon XM-220 (available from Mitsui Chemical of Tokyo, Japan), Mipelon XM-330 (Mitsui Chemical of Tokyo, Japan), Ticona GUR 4170 (Celanese of Dallas, Tex.), UTEC3040 (Braskem of Philadelphia, Pa.), Lubmer 5000 (Mitsui Chemical of Tokyo, Japan), and Lubmer 5220 (Mitsui Chemical of Tokyo, Japan).

In some embodiments, the UHMWPE may be in a powder or pellet form. The UHMWPE may have an average particle diameter of about 75 μm or less, about 70 μm or less, or about 65 μm or less. The UHMWPE may have an average particle diameter of 10 μm or greater, 15 μm or greater, 20 μm or greater, or 25 μm greater. In some embodiments, the UHMWPE may have an average particle diameter in a range from about 40 μm to about 75 μm, such as from about 50 μm to about 70 μm, or from about 55 μm to 65 μm. In some embodiments, the UHMWPE may have an average particle diameter in a range from about 10 μm to about 50 μm, such as from about 15 μm to about 45 μm, from about 20 μm to about 40 μm or from about 25 μm to about 30 μm.

The UHMWPE may be present in the TPV composition in an amount of about 5 wt % or greater, about 7 wt % or greater, about 9 wt % or greater, about 10 wt % or greater, or about 12 wt % or greater. The UHMWPE may be present in the TPV composition in an amount of about 40 wt % or less, about 35 wt % or less, about 30 wt % or less, about 25 wt % or less, about 20 wt % or less, or about 15 wt %, or about 12 wt % or less. In some embodiments, the UHMWPE is present in the TPV composition in an amount in a range from about 5 wt % to about 40 wt %, such as from about 5 wt % to 30 wt % or from about 7 wt % to about 15 wt %.

Other additives that may be useful in reducing the wear and abrasion resistance of the TPV compositions useful for external sheath and anti-wear intermediate layers of flexible pipes include perfluoropolyether (PFPE) synthetic oil (e.g., Fluoroguard® available from Chemours of Wilmington, Del.), PTFE (polytetrafluoroethylene), graphite, carbon fibers, carbon nanotubes, aramid fibers etc.

### Compatibilizers

In certain embodiments, the present TPV compositions may further include a compatibilizer. A thermoplastic compatibilizer for the rubber phase is useful in the present TPV compositions because of the decreased time for dispersion of the rubber as well as the decrease in particle size of the rubber domains, all while maintaining equivalent or better mechanical properties. Non-limiting examples of compatibilizers include styrenic block copolymers (such as styrene-butadiene-styrene and styrene-ethylene-butylene-styrene), copolymers of alpha-olefins (such as ethylene-octene, ethylene-butene, ethylene-propylene, and copolymers comprising olefin monomeric units and aromatic units, e.g., alpha-olefins with styrenics such as ethylene-styrene copolymers), and combinations thereof. The compatibilizers can be block copolymers, random copolymers, or pseudorandom copolymers.

In certain embodiments, the TPV compositions contain a diblock copolymer having isotactic polypropylene blocks and ethylene-propylene blocks. Examples of block copolymers contain isotactic polypropylene in a range from about 5 wt % to about 90 wt %. In certain embodiments, the block copolymer contains ethylene in the ethylene-propylene blocks in a range between about 5 wt % to about 70 wt %. In certain embodiments, the diblock copolymer is present in the TPV composition in an amount in a range from about 0.5 wt % to about 30 wt %, such as from about 1 wt % to about 20 wt % or from about 3 wt % to about 10 wt %. Exemplary polyolefin compatibilizers include but are not limited to Intune™ D5535, Intune™ D5545, and Intune™ 10510, Infuse™ 9000, Infuse™ 9007, Infuse™ 9100, Infuse™ 9107 available from The Dow Chemical Company of Midland, Mich.

In certain embodiments, the TPV compositions with compatibilizers show surprisingly, uniform dispersion of rubber domains within the thermoplastic vulcanizate composition, allowing the composition to be extruded into articles of the TPV compositions described herein having a thickness of about 2 mm or greater, such as a thickness of about 6 mm or greater, a thickness of about 10 mm or greater, or a thickness of about 15 mm or greater. Extruded articles of the TPV compositions described can have thicknesses of about 8 mm or greater and still exhibit effective cooling (i.e. cooling from an outer surface of the cross section to an inner surface of the cross section) at extrusion temperatures without sacrificing mechanical strength.

### Curing Systems

Any vulcanizing agent that is capable of curing or crosslinking the rubber employed in preparing the TPV may be used. For example, the cure agent may include peroxides, phenolic resins, free radical curatives, hydrosilation curatives, azide, or other suitable curatives. Depending on the rubber employed, certain curatives may be preferred. For example, where elastomeric copolymers containing units deriving from vinyl norbornene are employed, a peroxide curative may be preferred because the required quantity of peroxide will not have a deleterious impact on the engineering properties of the thermoplastic phase of the thermoplastic vulcanizate. In other situations, however, it may be preferred not to employ peroxide curatives because they may, at certain levels, degrade the thermoplastic components (e.g., polypropylene) of the thermoplastic vulcanizate.

In some embodiments, the rubber is cured or crosslinked by dynamic vulcanization. The term dynamic vulcanization refers to a vulcanization or curing process for a rubber contained in a blend with a thermoplastic resin, wherein the rubber is crosslinked or vulcanized under conditions of high shear at a temperature above the melting point of the thermoplastic. The rubber can be cured by employing a variety of curatives. Example cure systems include phenolic resin cure systems, hydrosilation cure systems, azide, and silane grafting/moisture cure systems.

In some embodiments, the rubber can be simultaneously crosslinked and dispersed as fine particles within the thermoplastic matrix, although other morphologies may also exist. Dynamic vulcanization can be effected by mixing the components at elevated temperature in conventional mixing equipment such as roll mills, stabilizers, Banbury mixers, Brabender mixers, continuous mixers, mixing extruders, and the like. Methods for preparing TPV compositions are described in U.S. Pat. Nos. 4,311,628, 4,594,390, 6,503,984, and 6,656,693, which are incorporated herein by reference for U.S. patent practice, although methods employing low shear rates can also be used. Multiple-step processes can also be employed whereby ingredients, such as additional thermoplastic resin, can be added after dynamic vulcanization has been achieved as disclosed in International Application No. WO 2005/028555, which is incorporated herein by reference for U.S. patent practice.

Useful phenolic cure systems are disclosed in U.S. Pat. Nos. 2,972,600, 3,287,440, 5,952,425 and 6,437,030, which are incorporated herein by reference for U.S. patent practice. In some embodiments, phenolic resin curatives include resole resins, which can be made by the condensation of alkyl substituted phenols or unsubstituted phenols with aldehydes, such as formaldehydes, in an alkaline medium or by condensation of bi-functional phenoldialcohols. The alkyl substituents of the alkyl substituted phenols may contain between about 1 and about 10 carbon atoms, such as dimethylolphenols or phenolic resins, substituted in para-positions with alkyl groups containing between 1 and 10 carbon atoms. In some embodiments, a blend of octylphenol-formaldehyde and nonylphenol-formaldehyde resins is employed. The blend includes from about 25 wt % to about 40 wt % octylphenol-formaldehyde and from about 75 wt % to about 60 wt % nonylphenol-formaldehyde, such as from about 30 wt % to about 35 wt % octylphenol-formaldehyde and from about 70 wt % to about 65 wt % nonylphenol-formaldehyde. In some embodiments, the blend includes about 33 wt % octylphenol-formaldehyde and about 67 wt % nonylphenol-formaldehyde resin, where each of the octylphenol-formaldehyde and nonylphenol-formaldehyde include methylol groups. This blend can be solubilized in processing oil (e.g., paraffinic oil) at about 30% solids without phase separation. The resultant blend is called Resin-In-Oil (RIO). Examples of phenolic resins that may be used in the present TPV compositions include SP-1044, and SP-1045 from the SI Group, Inc. of Schenectady, N.Y.

In some embodiments, the phenolic resin is used in combination with a halogen source, such as stannous chloride, acting as a cure accelerator. One example of a stannous chloride that may be used in the present TPV compositions is an anhydrous stannous chloride polypropylene masterbatch (herein referred to SnCl₂-45% MB) containing 45 wt % stannous chloride and 55 wt % of polypropylene having an MFR of 0.8 g/10 min (ASTM D1238; 230° C. and 2.16 kg weight). Other stannous chloride compositions may also be used. In some embodiments, the phenolic resin is used in combination with a metal oxide or reducing compound as a cure moderator, such as zinc oxide. Zinc oxide is available from Zochem, Inc. of Brampton, ON, Canada.

For example, a phenolic resin can be employed in an amount in a range from about 2 parts by weight to about 10 parts by weight per 100 parts by weight rubber (such as from about 3.5 parts by weight to about 7.5 parts by weight or from about 5 parts by weight to about 6 parts by weight). In some embodiments, the phenolic resin can be employed in conjunction with stannous chloride and optionally zinc oxide. The stannous chloride can be employed in an amount in a range from about 0.2 parts by weight to about 10 parts by weight per 100 parts by weight rubber (such as from about 0.3 parts by weight to about 5 parts by weight or from about 0.5 parts by weight to about 3 parts by weight). The zinc oxide can be employed in an amount in a range from about 0.25 parts by weight to about 5 parts by weight per 100 parts by weight rubber (such as from about 0.5 parts by weight to about 3 parts by weight or from about 1 parts by weight to about 2 parts by weight). In one or more embodiments, the rubber employed with the phenolic curatives includes diene units deriving from 5-ethylidene-2-norbornene.

The curative, such as a phenolic resin, may be introduced into the vulcanization process in a solution or as part of a dispersion. In certain embodiments, the curative is introduced to the vulcanization process in an oil dispersion/solution, such as a curative-in-oil or a phenolic resin-in-oil, where the curative/resin is dispersed and/or dissolved in a processing oil. The processing oil used may be a mineral oil, such as an aromatic mineral oil, naphthenic oil, paraffinic mineral oils, or combination thereof.

In some embodiments, hydrosilation cure systems may include silicon hydride reducing agent compounds having at least two Si—H groups, such as polysiloxanes and polyorganosiloxanes. Silicon hydride compounds that are useful in practicing the present disclosure include methylhydrogenpolysiloxanes, methylhydrogendimethylsiloxane copolymers, alkylmethyl-co-methylhydrogenpolysiloxanes, bis(dimethylsilyl)alkanes, bis(dimethylsilyl)-benzene, and mixtures thereof. Additional examples of multi-functional organosilicon compounds include polymethylhydrodimethylsiloxane copolymers terminated with trimethylsiloxy groups or alkoxy groups; polymethylhydrosiloxane polymers similarly terminated. In certain embodiments, the silicon hydride reducing agent compound is a trimethyl silyl terminated methyl hydrogen methyloctyl siloxane.

Surprisingly, the silicon hydride reducing agent compounds also act as an effective abrasion resistance enhancing agent or slip agent as wells as acting as a hydrosilation based crosslinking agent. In one or more embodiments, these hydrosilating agents may be characterized by a molecular weight in a range from about 200 g/mole to about 800,000 g/mole, in other embodiments in a range from about 300 g/mole to about 300,000 g/mole, and in other embodiments in a range from about 400 g/mole to about 150,000 g/mole. One example of a silicon hydride compound includes Xiameter OFX-5084 available from Dow Corning of Midland, Mich.

Specific examples of hydrosilating agents, which may also be referred to as HQ-type resins or hydride-modified silica Q resins, include those compounds that are commercially available under the trade name MQH-9™ (available from Clariant of Muttenz, Switzerland), which is a hydride-modified silica Q resin characterized by a molecular weight of 900 g/mole and an activity of 9.5 equivalents/kg; HQM 105™ (available from Gelest of Morrisville, Pa.), which is a hydride modified silica Q resin characterized by a molecular weight of 500 g/mole and an activity of 8-9 equivalents/kg; and HQM 107™ (available from Gelest of Morrisville, Pa.), which is a hydride-modified silica Q resin characterized by a molecular weight of 900 g/mole and an activity of 8-9 equivalents/kg. In one or more embodiments, the rubber employed with the hydrosilation curatives includes diene units deriving from 5-vinylidene-2-norbornene.

Useful catalysts include those compounds or molecules that can catalyze the hydrosilation reaction between a reactive SiH-containing moiety or substituent and a carbon-carbon bond such as a carbon-carbon double bond. Also, in one or more embodiments, these catalysts may be soluble within the reaction medium. Types of catalysts include transition metal compounds including those compounds that include a Group VIII metal. Exemplary Group VIII metals include palladium, rhodium, germanium, and platinum. Exemplary catalyst compounds include chloroplatinic acid, elemental platinum, chloroplatinic acid hexahydrate, complexes of chloroplatinic acid with sym-divinyltetramethyldisiloxane, dichloro-bis(triphenylphosphine) platinum (II), cis-dichloro-bis(acetonitrile) platinum (II), dicarbonyldichloroplatinum (II), platinum chloride, and platinum oxide, zero valent platinum metal complexes such as Karstedt's catalyst, solid platinum supported on a carrier (such as alumina, silica or carbon black), platinum-vinylsiloxane complexes {for instance: Ptₙ(ViMe₂SiOSiMe₂Vi)ₙ and Pt[(MeViSiO)₄]ₘ}, platinum-phosphine complexes {for example: Pt(PPh₃)₄ and Pt(PBU₃)₄}, and platinum-phosphite complexes {for instance: Pt[P(OPh)₃]₄ and Pt[P(OBu)₃]₄}, wherein Me represents methyl, Bu represents butyl, Vi represents vinyl and Ph represents phenyl, and n and m represent integers. Other catalyst compounds include RhCl(PPh₃)₃, RhCl₃, Rh/Al₂O₃, RuCl₃, IrCl₃, FeCl₃, AlCl₃, PdCl₂.2H₂O, NiCl₂, TiCl₄, and the like.

In one or more embodiments, the catalysts may be employed in conjunction with a catalysts inhibitor. These inhibitors may be particularly advantageous where thermoplastic vulcanizates are prepared by using dynamic vulcanization processes. Useful inhibitors include those compounds that stabilize or inhibit rapid catalyst reaction or decomposition. Exemplary inhibitors include olefins that are stable above 165° C. Other examples include 1,3,5,7,-tetravinyltetramethylcyclotetrasiloxane.

Those skilled in the art will be able to readily select an appropriate amount of hydrosilating agent to effect a desired cure. In one or more embodiments, the amount of hydrosilating agent employed may be expressed in terms of the ratio of silicon hydride equivalents (i.e., number of silicon hydride groups) to the equivalents of vinyl double bonds (e.g. number of diene-derived units on the polymer). In certain embodiments, a deficiency of silicon hydride is employed. In other embodiments, an excess of silicon hydride is employed. In one or more embodiments, the ratio of equivalents of silicon hydride to equivalents of vinyl bonds on the rubber is in a range from about 0.7:1 to about 10:1, in other embodiments in a range from about 0.95:1 to about 7:1, in other embodiments in a range from 1:1 to 5:1, and in other embodiments in a range from 1.5:1 to 4:1.

In some embodiments of a hydrosilation cure system, the silicon hydride reducing agent compounds may be employed in an amount in a range from about 0.5 parts by weight to about 5.0 parts by weight per 100 parts by weight of rubber (such as from about 1.0 parts by weight to about 4.0 parts by weight or from about 2.0 parts by weight to about 3.0 parts by weight). A complementary amount of catalyst may include metal in a range from about 0.5 parts to about 20.0 parts per million parts by weight of the rubber (such as from about 1.0 parts to about 5.0 parts or from about 1.0 parts to about 2.0 parts).

In certain embodiments of a hydrosilation cure system, the silicon hydride reducing agent compounds may be employed in an amount in with the molar equivalent of the Si—H groups per kilogram of the reducing agent is in a range from 0.1 to 100. In certain embodiments of a hydrosilation cure system, the silicon hydride reducing agent compounds have a number average molecular weight in a range from about 0.2 kg/mol to about 100 kg/mol.

In certain embodiments, the cure system comprises a moisture-curable silane compound cured by exposing the blend to moisture (such a steam, hot water, cold water, or ambient moisture). The silane compound can be grafted onto the polyethylene resin by reactive extrusion, and the graft resin can be mixed with a masterbatch comprising moisture-curing catalyst. One example of a moisture-cure catalyst is Silfin 63 available from Evonik of Parsippany, N.J.

In some embodiments, a free-radical vulcanizing agent, such as peroxides, for example organic peroxides, may be used. Examples of organic peroxides include, but are not limited to, di-tert-butyl peroxide, dicumyl peroxide, t-butylcumyl peroxide, alpha-bis(tert-butylperoxy) diisopropyl benzene, 2,5-dimethyl-2,5-di(t-butylperoxy)hexane (DBPH), 1,1-di(tert-butylperoxy)3,3,5-trimethyl cyclohexane, n-butyl-4,4-bis(tert-butylperoxy) valerate, benzoyl peroxide, lauroyl peroxide, dilauroyl peroxide, 2,5-dimethyl-2,5-di(tert-butylperoxy) hexyne-3, and mixtures thereof. Also, diaryl peroxides, ketone peroxides, peroxydicarbonates, peroxyesters, dialkyl peroxides, hydroperoxides, peroxyketals, and mixtures thereof may be used. The peroxide may be diluted in a processing oil, such as a low aromatic/sulfur content oil, and be used to produce the thermoplastic vulcanizates described herein.

The free-radical curative may be used in conjunction with a coagent. Useful coagents include high-vinyl polydiene or polydiene copolymer, triallylcyanurate, triallyl isocyanurate, triallyl phosphate, sulfur, N-phenyl bis-maleamide, divinyl benzene, trimethylol propane trimethacrylate, tetramethylene glycol diacrylate, trifunctional acrylic ester, dipentaerythritolpentacrylate, polyfunctional acrylate, retarded cyclohexane, dimethanol diacrylate ester, polyfunctional methacrylates, acrylate and methacrylate metal salts, multi-functional acrylate esters, multi-functional methacrylate esters, or a combination thereof, or oximers such as quinone dioxime.

### TPV Compositions

One example of a method of making TPV compositions includes introducing an elastomer to an extrusion reactor; introducing a thermoplastic resin to the extrusion reactor; introducing a filler, an additive, or a combination of filler and additive to the extrusion reactor; introducing a first amount of processing oil to the extrusion reactor at a first oil injection location; introducing a curative to the extrusion reactor at a location that is downstream of the first or second oil injection location (if second amount of oil injection is applicable); introducing a second amount of processing oil to the extrusion reactor at a second oil injection location, where the second oil injection location is downstream of the location where the curative is introduced to the extrusion reactor; and dynamically vulcanizing the elastomer with the curative in the presence of the thermoplastic resin to form the TPV composition, wherein the TPV composition comprises a rubber phase that is dispersed and at least partially cross linked within a continuous thermoplastic matrix.

In some embodiments, the rubber can be highly cured. In some embodiments, the rubber is advantageously partially or fully/completely cured. The degree of cure can be measured by determining the amount of rubber that is extractable from the thermoplastic vulcanizate by using cyclohexane or boiling xylene as an extractant. This method is disclosed in U.S. Pat. No. 4,311,628, which is incorporated herein by reference for U.S. patent practice. In some embodiments, the rubber has a degree of cure where not more than about 5.9 wt %, such as not more than about 5 wt %, such as not more than about 4 wt %, such as not more than about 3 wt % is extractable by cyclohexane at 23° C. as described in U.S. Pat. Nos. 5,100,947 and 5,157,081, which are incorporated herein by reference for U.S. patent practice. In these or other embodiments, the rubber is cured to an extent where greater than about 94 wt %, such as greater than about 95 wt %, such as greater than about 96 wt %, such as greater than about 97 wt % by weight of the rubber is insoluble in cyclohexane at 23° C. Alternately, in some embodiments, the rubber has a degree of cure such that the crosslink density is at least 4×10⁻⁵ moles per milliliter of rubber, such as at least 7×10⁻⁵ moles per milliliter of rubber, such as at least 10×10⁻⁵ moles per milliliter of rubber. See also “Crosslink Densities and Phase Morphologies in Dynamically Vulcanized TPEs,” by Ellul et al., RUBBER CHEMISTRY AND TECHNOLOGY, Vol. 68, pp. 573-584 (1995).

Whether the rubber is partially cured or fully cured the compositions of this disclosure can be processed and reprocessed by conventional plastic processing techniques such as extrusion, injection molding, blow molding, and compression molding. The rubber within these thermoplastic elastomers can be in the form of finely-divided and well-dispersed particles of vulcanized or cured rubber within a continuous thermoplastic phase or matrix. In the embodiments where the cured rubber is in the form of finely-divided and well-dispersed particles within the thermoplastic medium, the rubber particles can have an average diameter that is about 50 μm or less (such as about 30 μm or less, such as about 10 μm or less, such as about 5 μm or less, such as about 1 μm or less). In some embodiments, at least about 50%, such as about 60%, such as about 75% of the particles have an average diameter of about 5 μm or less, such as about 2 μm or less, such as about 1 μm or less.

In some embodiments, the TPV compositions have one, more, or all of the following characteristics:

1) An amount of rubber that in a range from about 5 wt % to about 70 wt %, such as in a range from about 10 wt % to about 30 wt %, based upon the total weight of the TPV composition.

2) An amount of thermoplastic polyolefin in a range from about 20 wt % to about 80 wt %, such as in a range from about 30 wt % to about 70 wt %.

3) A cyclic olefin copolymer in a weight percent in a range from about 0.1 wt % to about 30 wt %, such as in a range from about 1 wt % to about 10 wt %.

4) A hydrocarbon resin in a weight percent in a range from about 0.1 wt % to about 30 wt %, such as in a range from about 1 wt % to about 10 wt %.

5) A polyolefin compatibilizer, preferably a block copolymer, in a weight percent in a ranger from about 0.1 wt % to about 30 wt %, such as in a range from about 0.5 wt % to about 10 wt %.

6) A slip agent in a weight percent in a range from about 0.1 wt % to about 30 wt %, such as in a range from about 1 wt % to about 10 wt %.

7) For phenolic cure systems, a phenolic cure agent in a suitable amount to partially or fully cross-link the rubber.

8) A hydrosilating agent present in the ratio of equivalents of Si—H groups of silicon hydride compounds to equivalents of vinyl bonds (carbon-carbon double bonds) of the rubber is from about 0.7:1 to about 10:1, in other embodiments from about 0.95:1 to about 7:1, in other embodiments 1:1 or greater, such as from 1:1 to 5:1; in other embodiments 2:1 or greater, such as from 2:1 to 4:1.

9) A processing oil which is compatible with both the rubber and polyolefin present in an amount from about 1 to about 250 phr.

10) A processing oil in a weight percent in a range from about 1 wt % to about 40 wt %.

11) A CO₂ gas permeability measured at 60° C. according to ISO 2782-1 of 1 barrer or more, such as about 10 barrers or more, such as about 20 barrers or more, or such as about 30 barrers or more.

12) A Shore A hardness of about 60 or more and a Shore D hardness of about 60 or less, such as a Shore A hardness in a range from about 70 Shore A to about 90 Shore A, and a Shore D hardness in a range from about 20 Shore D to about 60 Shore D, such as from about 30 Shore D to about 50 Shore D.

13) An abrasion loss as measured according to ASTM D4060 of about 100 mg/1000 cycle or less, such as an abrasion resistance of about 80 mg/1000 cycle or less, or such as an abrasion loss of about 60 mg/1000 cycle or less. The TPV compositions may have abrasion resistance provided by hydrosilation cure without any additional anti-friction slip agents or provided by phenolic cure and a siloxane-based or ultra-high molecular weight an slip agent without any other anti-friction fillers/agents.

14) A thermal conductivity of about 0.30 W/m.K or less, such as about 0.2 W/m.K or less or about 0.18 W/m.K or less.

15) A tensile stress @ 7% of about 6 MPa or more, such as about 9 MPa or more.

16) A Young's Modulus of about 250 MPa or more, such as about 300 MPa or more or about 350 MPa or more.

17) A tensile strength at yield of about 5 MPa or more, such as in a range from about 8 MPa to about 23 MPa, or a tensile strength at yield of about 9 MPa or more, such as in a range from about 11 MPA to about 15 MPa.

18) A tensile strain at yield of a tensile strain at yield ranging from a low of about 5%, about 15%, or about 25% to a high of about 100%, or about 200%.

19) A creep strain measured at 23° C. under a total stress of 4 MPa of about 100% or less, such as about 40% or less or such as about 10% or less.

### Articles

Certain embodiments of the present TPV compositions are used to form articles made by extrusion and/or co-extrusion, blow molding, injection molding, thermo-forming, elasto-welding, compression molding, 3D printing, pultrusion, and other fabrication techniques. Certain embodiments of the present TPV compositions are used to form flexible pipes, tubing, hoses, and flexible structures, such as flexible pipes, flow lines and flexible umbilicals used in transporting fluids in petroleum production. The flexible structures can transport hydrocarbons extracted from an offshore deposit and/or can transport water, heated fluids, and/or chemicals injected into the formation in order to increase the production of hydrocarbons. Certain embodiments of the present TPV compositions are used to form the outer covering of a thermoplastic composite pipe.

Certain embodiments of the present TPV compositions include polymeric layers sheaths positioned as inner, intermediate or outer layers of: 1) unbonded or bonded flexible pipes, tubes and hoses with a structure similar to those described in API Spec 17J and API Spec 17K, and 2) thermoplastic umbilical hoses similar to those described in API 17E, or 3) thermoplastic composite pipes with a structure similar to those described in DNV RP F119. In other embodiments, the present thermoplastic vulcanizate composition is used in composite tapes (e.g., carbon fibers, carbon nanotubes or glass fibers embedded in a thermoplastic matrix) used in thermoplastic composite pipes with a structure similar to those described in DNV RP F119. Specific embodiments of flexible pipe structures are described below.

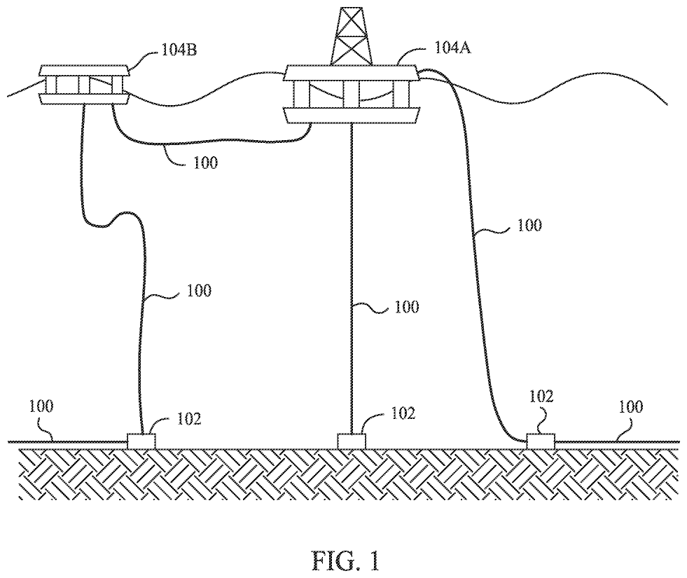

FIG. 1 illustrates various flexible structures 100 suitable for transporting fluids such as hydrocarbons, oil, gas, water, injection fluids, control fluids, and/or other fluids between a subsea location 102 and a floating facility 104, between a subsea location 102 to another subsea location 102, between two floating facilities 104, or between a subsea location 102 to an onshore facility. The floating facility 104 may be a platform 104A, a buoy 104B, a ship, or other floating structures. Certain embodiments of the flexible structures 100 may be any type of risers, such as attached risers (i.e., deployed on fixed structures), pull tube risers (i.e., tread up the center of a pull tube), top-tensioned risers (i.e., vertical risers), riser towers (i.e., risers used to lift risers to the sea's surface), flexible risers (i.e., vertical and horizontal risers), drilling risers (i.e., transferring mud), and other types of risers. Certain embodiments of the flexible structures 100 may be a subsea flow line, which may be resting on the sea floor or buried below the sea floor.

The demand for oil is causing oil exploration and production to occur at greater and greater sea depths where environmental factors to the flexible structures 100 are more extreme. Oil industry initially conducted oil production in deep water of up to 3,000 feet, then to ultra-deep water up 6,000 feet, and then to water depths of greater than 6,000 feet. The lifetimes of typical subsea oil wells is up to 20 years. It is difficult and expensive to replace or repair flexible structures 100. The flexible structures 100 are exposed to various environmental factors such as corrosion, pressure, and temperature from sea water; corrosion, pressure, and temperature from the transferred fluids; forces from waves and current; and tension and weight of the flexible structures 100. For example, the sea water pressure at a depth of 6,500 feet is about 200 bar. The temperature and the pressure of hydrocarbons produced from the subsea well head may be 110° C. or more, such as 130° C., and with pressures of 300 bar or more. The temperature and pressure of the hydrocarbons may be a result of the temperature of the earth below the subsea bed and/or from injected production fluid such as steam. In contrast, the sea water temperature may lower than 0° C. down to below 25° C.

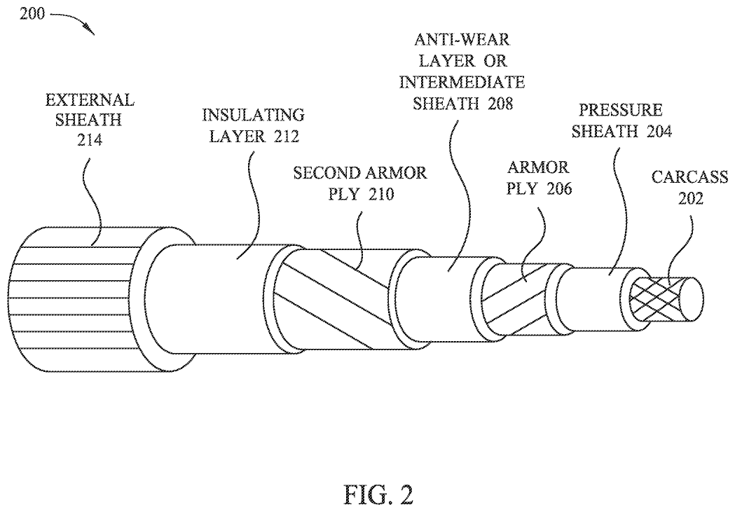

FIG. 2 is a schematic diagram of certain embodiments of a multiple layer flexible pipe 200 that may be used as flexible structure 100 of FIG. 1. One or more of the layers of the multilayer flexible structure 200 may be comprised of the present TPV compositions.

The multiple layer flexible pipe 200 is formed of a pipe body composed of multiple layers and one or more end fittings. The pipe body is typically formed as a composite of layered materials that form a fluid and pressure-containing conduit. The multiple layer flexible pipe 200 may bend without impairing the pipe's functionality over its lifetime. The multiple layer flexible pipe 200 is exposed to various loads, such an internal pressure in the interior of the multiple layer flexible pipe 200, external pressure of the outside sea water, and tension and weight of the multiple layer flexible pipe 200.

The present TPV compositions possess excellent processability such that the compositions can be extruded as a single layer or extruded as tapes and wrapped around a interior pipe layer for use in the manufacture of one or more layers of the multiple layer flexible pipe 200. The present TPV compositions do not require the foaming of polymers to achieve low thermal conductivity before extruding it as a single layer. Present TPV compositions provide one or more layers of the multiple layer flexible pipe 200 with low thermal conductivity to be extruded as a single layer, such as an insulating layers 212, without the need for foaming agents.

The multiple layer flexible pipe 200 may include an optional carcass 202, such as a helically wound metal layer, interconnected metallic metal elements, and/or metal wire embedded in polymer. The carcass 202 provides collapse resistance for the multiple layer flexible pipe 200.

The multiple layer flexible pipe 200 includes an inner polymer sheath or layer called pressure sheath 204. The inner polymeric layer or pressure sheath 204 is a fluid barrier layer for transporting the fluid and acts a barrier to prevent the fluid from escaping the interior of the pressure sheath 204. The pressure sheath 204 may be extruded

An armor ply 206 may surround the pressure sheath 204. The armor ply 206 may be used to provide hoop and axial strength. The armor ply 206 may be a metallic layer, such as a helically wound metal layer, interconnected metallic metal elements, and/or metal wire embedded in polymer. A second armor ply 210 may surround the armor ply 206. The second armor ply 210 provides additional hoop and axial strength for higher pressure applications. The second armor ply 210 may be a metallic layer, such as a helically wound metal layer, interconnected metallic metal elements, or metal wire embedded in polymer

An anti-wear layer or intermediate sheath 208 is disposed between the armor ply 206 and the second armor ply 210 if a second armor ply is used. The anti-wear layer 208 prevents premature wear of these armor plies 206, 210 from being directly in contact with each other and permits the armor ply 206 and the second armor ply 210 to move and flex relative to one another when the multiple layer pipe 200 bends. The anti-wear layer 208 may be an extruded continuous layer, a helically wound layer, or multiple layers thereof. In certain embodiments, the anti-wear layer 208 comprises the present TPV compositions having high abrasion resistance, good flexibility, and good fatigue resistance at a low cost. The TPV compositions useful as layers in flexible pipes may include a filler or additive intended to reduce the coefficient of friction of the composition so that the armor plies can act relative to one another when the pipe bends. The intermediate TPV composition layer permits the armors to rub against the intermediate TPV composition layer even when high pressures are exerted. According to certain embodiments, the TPV composition has a proportion by weight of filler of less than 20%. This results in a good coefficient of friction and abrasion resistance of the intermediate layer against the armor plies, while still maintaining mechanical performance sufficient for the application.

TPV compositions may be formed as a continuous layer or as extruded long tapes helically wound around the armor ply 206. In certain embodiments, the TPV compositions described herein forming the anti-wear layer have an abrasion resistance of 60 mg/1000 cycle or less. The TPV compositions may have abrasion resistance provided by hydrosilation cure without any additional anti-friction fillers/agents or provided by phenolic cure and a siloxane-based slip agent without any other anti-friction fillers/agents. In addition, anti-friction fillers may be further added to the TPV compositions to further provide abrasion resistance to the anti-wear layer 208. For example, the TPV compositions may include anti-friction fillers, such as molybdenum based compounds (e.g. molybdenum disulfide) and/or fluorinated polymers, is a range from 0.5 wt % to 20 wt %. In certain embodiments, the TPV compositions having a CO₂ gas permeability of 30 barrers or more is used to form the anti-wear layer 208 so that carbon dioxide and hydrogen sulfides may permeate out of the anti-wear layer 208 to reduce corrosion of the metal wire of the armor ply 206.

An insulating layer 212 may surround the pressure sheath 204, the armor ply 206, and/or the second armor ply 210 (as shown in FIG. 2). The insulating layer 212 provides thermal insulation to the interior of the pressure sheath 204 of the multiple layer flexible pipe 200. For example, the insulating layer 212 helps to main the high temperature within the interior of the pressure sheath 204 from the cold temperature of the outside sea water. If the fluid within the interior of the inner liner 200 falls or cools, such as due to the cold temperature of the outside sea water, paraffin may undesirably form and buildup restricting or blocking the flow of fluid within the interior of the inner liner 200. In certain embodiments, the insulating layer 212 acts as barrier against outside sea water intrusion and/or transferred fluid leakage. In certain embodiments, the insulating layer 212 is comprised of TPV compositions disclosed herein have a thermal conductivity of 0.3 W/m.K or less, such as 0.2 W/m.K or less, or 0.18 W/m.K or less, to help maintain the high temperatures within the interior of the pressure sheath 204. Trapped carbon dioxide and hydrogen sulfides with the interior of the insulating layer 212 may undesirably corrode the metal in the armor ply 206 and/or armor ply 210. Corrosion of the metal in the armor ply 206 and/or armor ply 210 reduces the lifetime of the multi-flexible pipe 200. In certain embodiments, the TPV compositions described herein used to form the insulating layer 212 have a CO₂ gas permeability of 30 barrers or more is used to form the insulating layer 212 so that carbon dioxide and hydrogen sulfides may permeate out of the insulating layer 212 to reduce the amount of carbon dioxide and hydrogen sulfides trapped within the interior of the insulating layer 212 and to reduce corrosion in the metal of the armor ply 206 and/or second armor ply 210.

In certain embodiments, the excellent processability and low thermal conductivity the TPV compositions forming the insulation layer 212 allows into be extruded directly onto the outside of the pressure sheath 204, the armor ply 206 and/or the second armor ply 210 to reduce the number of manufacturing steps and cost when compared to conventional flexible pipes. In certain embodiments, the insulation layer 212 is extruded directly onto the outside of the armor ply 206 and/or second armor ply 210 and sealed to an end fitting so that sea water cannot flow into the interior and generate a corrosive environment for any metal of the multiple layer flexible pipe 200. By extruding the insulation layer 212 onto the outside of the armor ply 206 and/or armor ply 210 and sealing the insulation layer 212 in the end fitting, flooding of the interior of the multiple layer flexible pipe 200 may be avoided in the case of damage to an external sheath surrounding the insulation layer 212. In certain embodiments, extrusion of the insulation layer 212 comprised of present TPV compositions resists water penetration from the outside sea water in comparison with a helically wound tapes which may have gap defects in the windings during manufacture or may easily be displaced in the case of failure of an external sheath.

An external sheath 214 may surround the pressure sheath 204, the armor ply 206, the second armor ply 210, and/or the insulating layer 212. The external sheath 214 may be an extruded continuous layer, a helically wound layer, or multiple layers thereof. The external sheath 214 protects against ingress of seawater into the interior and protects the multiple layer flexible pipe from external environmental conditions and forces, such as corrosion, abrasion, and mechanical damage. In certain embodiments, the external sheath 214 comprises present TPV compositions having an abrasion resistance of 60 mg/1000 cycle or less. The surprisingly high abrasion resistance allows the use of such TPV compositions as external sheath of flexible pipes.

In certain embodiments, the external sheath 214 comprises present TPV compositions having a yield strength of 9 MPA or more. In certain embodiments, the external sheath 214 comprises present TPV compositions having a creep strain of 12% or less. In certain embodiments, the external sheath 214 comprises present TPV composition having a hardness in a range from 20 Shore D to 60 Shore D, such as from 30 Shore D to 50 Shore D. In certain embodiments, the external sheath 214 comprises present TPV compositions further including glass microspheres functioning as high pressure resistance elements.

In certain embodiments, the present TPV compositions used to form the external sheath 214 have a CO₂ gas permeability in barrers of 30 more so that carbon dioxide and hydrogen sulfides may permeate out of the external sheath 214 to reduce the amount of carbon dioxide and hydrogen sulfides trapped within the interior of the external sheath 214 and to reduce corrosion in the metal of the armor ply 206 and/or second armor ply 210.

The layers of the multiple layer flexible pipe 200 as described in reference to FIG. 2 may each comprise one or more layers. The layers of the multiple layer flexible pipe 200 as described in reference to FIG. 2 may be combined. For example, in certain embodiments, the high CO₂ permeability, excellent abrasion resistance, and low thermal conductivity allows the external sheath 214 and the insulating layer 212 to be combined and formed as a single layer. The layers of the multiple layer flexible pipe 200 as described in reference to FIG. 2 may be disposed in other orders. For example, the insulating layer 212 may be disposed on the pressure sheath 204 and the armor ply 206 may be disposed on the insulating layer 212. The multiple layer flexible pipe 200 as described in reference to FIG. 2 may comprise additional layers or less layers. Each layer of the multiple layer flexible pipe 200 may be bonded or unbonded to an adjacent layer. Adjacent layers may be bonded by using adhesive, by applying heat, and/or by applying pressure to the layers. The multiple layer flexible pipe 200 may be further combined with one or more other flexible pipes and/or umbilical lines (electrical, optical, hydraulic, control, etc.) into a single construction to form a multibore pipe.

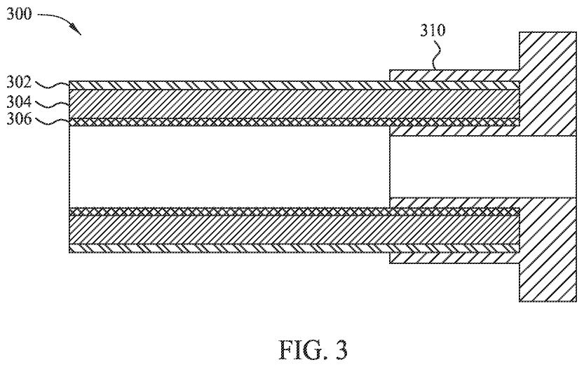

FIG. 3 is a schematic diagram of certain embodiments of a thermoplastic composite pipe 300 that may be used as flexible structure 100 of FIG. 1. Thermoplastic composite pipes 300 are flexible bonded structures and the composites are fiber reinforced laminates with a thermoplastic matrix. The pipes are similar to composite pipes made of fiber reinforced thermoset composites. However, the thermoplastic material is more flexible allowing the thermoplastic composite pipes 300 to be used in applications where higher bending strains are needed.

The thermoplastic composite pipe 300 includes a liner 302, a thermoplastic composite pipe laminate 304 surrounding the liner, and a cover 306 surrounding the thermoplastic composite pipe laminate. One or both ends of the pipe 300 may optionally include an end fitting 310. One or more of the layers of the thermoplastic composite pipe 300 may be comprised of the present TPV compositions.

In one embodiment, the cover 306 is comprised of the present TPV compositions. The processability of the present TPV compositions enables the compositions to be extruded as a single layer over the thermoplastic composite pipe laminate 304 with the use of forming agents.

The cover 306 protects against ingress of seawater into the interior and protects the thermoplastic composite pipe 300 from external environmental conditions and forces, such as corrosion, abrasion, and mechanical damage. In certain embodiments, the cover 306 comprises present TPV compositions having an abrasion resistance of 60 mg/1000 cycle or less. In certain embodiments, the cover 306 comprises present TPV compositions having a yield strength of 9 MPA or more. In certain embodiments, the cover 306 comprises present TPV compositions having a creep strain of 12% or less. In certain embodiments, the cover 306 comprises present TPV composition having a Shore A hardness of about 60 or more and a Shore D hardness of about 60 or less, such as a Shore A hardness in a range from about 70 Shore A to about 90 Shore A, and a Shore D hardness in a range from about 20 Shore D to about 60 Shore D, such as from about 30 Shore D to about 50 Shore D.

In certain embodiments, the present TPV compositions used to form the cover 306 having a CO₂ gas permeability in barrers of 30 more so that carbon dioxide and hydrogen sulfides may permeate out of the cover 306 to reduce the amount of carbon dioxide and hydrogen sulfides trapped within the interior of the cover 306.

### Examples

### Sample Preparation Using a Brabender Mixer

Thermoplastic vulcanizate preparation was carried out under nitrogen in a laboratory Brabender-Plasticorder (model EPL-V5502). The mixing bowls had a capacity of 85 ml with the cam-type rotors employed. The plastic was initially added to the mixing bowl that was heated to 180° C. and at 100 rpm rotor speed. After plastic melting (2 minutes), the rubber, inorganic additives, and processing oil were packed into the mixer. After homogenization of the molten polymer blend (in 3-4 minute a steady torque was obtained), the curative was added to the mix, which caused a rise in the motor torque.

Mixing was continued for about 4 more minutes, after which the molten TPV was removed from the mixer, and pressed when hot between Teflon plates into a sheet which was cooled, cut-up, and compression molded at about 400° F. A Wabash press, model 12-1212-2 TMB was used for compression molding, with 4.5″×4.5″×0.06″ mold cavity dimensions in a 4-cavity Teflon-coated mold. Material in the mold was initially preheated at about 400° F. (204.4° C.) for about 2-2.5 minutes at a 2-ton pressure on a 4″ ram, after which the pressure was increased to 10-tons, and heating was continued for about 2-2.5 minutes more. The mold platens were then cooled with water, and the mold pressure was released after cooling (140° F.). Dog-bones were cut out of the molded (aged at room temperature for 24 hours) plaque for tensile testing (0.16″ width, 1.1″ test length (not including tabs at end)).

### Sample Preparation Using a Twin Screw Extruder (TSE)

The following description explains the process employed in the following samples unless otherwise specified. A co-rotating, fully intermeshing type twin screw extruder, supplied by Coperion Corporation, Ramsey N.J., was used following a method similar to that described in U.S. Pat. Nos. 8,011,913, 4,594,390, and US 2011/0028637 (excepting those altered conditions identified here), which are incorporated herein by reference for U.S. patent practice. Rubber was fed into the feed throat of a ZSK 53 extruder. The thermoplastic resin was also fed into the feed throat along with other reaction rate control agents, such as zinc oxide and stannous chloride if applicable. Fillers were also added into the extruder feed throat. Processing oil was injected into the extruder at two different locations along the extruder. The curative was injected into the extruder after the rubber, thermoplastics and fillers commenced blending and after the introduction of first processing oil (pre-cure oil). The curative may also be injected with the processing oil, which oil may or may not have been the same as the other oil introduced to the extruder or the oil the rubber was extended with. A second processing oil (post-cure oil) was injected into the extruder after the curative injection. Rubber crosslinking reactions were initiated and controlled by balancing a combination of viscous heat generation due to application of shear, barrel temperature set point, use of catalysts, and residence time.

In order to demonstrate the practice of the present disclosure, the following examples have been prepared and tested. The examples should not, however, be viewed as limiting the scope of the present disclosure.

### Comparative Examples C-A and C—B

Comparative examples C-A and C—B are materials used as one or more layers in currently available flexible pipes for fluid transportation in petroleum production described in the “Articles” section. Comparative example C-A is a polyamide resin under the product name PA11 BESNO P40 TL available from Arkema of King of Prussia, Pa. Comparative example C—B is a copolymer under the product name Eltex TUB121 available from INEOS Olefins & Polymers USA located in League City, Tex. Comparative example C-A and comparative example C—B were tested on injection molded samples. Table 1 sets forth the results of physical testing that was performed on each sample.

TABLE 1
Comparative Examples of Materials Used in Currently
Used in Flexible Pipes for Petroleum Production

| | C-A (Polyamide) | C-B (Copolymer) |
|---|---|---|
| Stress @ 7%, MPa | 15.6 | 22.9 |
| Yield Strength, MPa | 25.3 | 23.2 |
| Yield Strain, % | 50.7 | 9.4 |
| CO₂ Gas Permeability | 6.1 | 9.1 |
| (@ 60° C.) | | |
| Abrasion loss, mg/ | 33.5 | 50.0 |
| 1000 cycle | | |
| Thermal conductivity, | 0.248 | 0.381 |
| W/m · K | | |
| Creep strain (@ 23° C., | 4 | 2 |
| 4 MPa) after 1 week, % | | |

### Phenolic Cure, Hydrosilation Cure, and Moisture Cure of TPV Compositions

Comparative example C-1 is a TPV composition comprising a polypropylene thermoplastic and an EPDM rubber that was cured using a phenolic cure. Example 1 is a TPV composition comprising a polypropylene thermoplastic and an EPDM rubber that was cured using a hydrosilation cure. Example 2 is a TPV composition comprising a high density polyethylene thermoplastic and a vinyl terminated methoxy silane grafted on an ethylene octene plastomer that was cured using a moisture cure. Comparative examples C-1 and Examples 1 and 2 were each prepared on a twin-screw extruder and were tested on compression molded plaque samples. Table 2 sets forth the ingredients and amounts (part by weight) employed used in each sample and the results of physical testing that was performed on each sample.

TABLE 2
Comparison of Phenolic Cure, Hydrosilation
Cure, and Silane Grafting/Moisture Cure

| | | |
|---|---|---|
| C1 | Ex 1 | Ex 2 |

Formulation (part by weight)

| | | | |
|---|---|---|---|
| EPDM(E)-1 | 175 | | |
| EPDM(V)-1 | | 200 | |
| Engage 8150 | | | 100 |
| Braskem F008F | 451 | 515.43 | |
| HD7800P | | | 170 |
| ZnO | 2 | 2 | |
| SnCl₂-45% MB | 1.67 | | |
| Phenolic resin in Oil | 12.82 | | |
| Xiameter OFX-5084 | | 2.5 | |
| Platinum catalyst, PC0985 | | 0.007123 | |
| Silfin 63 | | | 3 |
| Water | | | 3 |
| Calcium Stearate/Irganox B4329 | | 1.59 | |
| Paramount 6001R | 49.32 | 61 | 20 |

Properties

| | | | |
|---|---|---|---|
| Hardness, Shore D | 51 | 48 | 46 |
| Stress @ 7%, MPa | 9.7 | 9.9 | 11.0 |
| Young's Modulus, MPa | 366 | 370 | 566 |
| Yield Strength, MPa | 12.0 | 12.2 | 12.5 |
| Yield Strain, % | 29.4 | 27.1 | 34.4 |
| CO₂ Gas Permeability | 58 | 62 | 61 |
| (@ 60° C.) | | | |
| Abrasion loss, mg/ | 110 | 57.5 | 57 |
| 1000 cycle-ranges | | | |
| Thermal conductivity, | 0.193 | 0.193 | 0.214 |
| W/m · K-ranges | | | |
| Creep strain | 10 | 6 | 6 |
| (@ 23° C., 4 MPa) | | | |
| after 1 week, % | | | |

Both Example 1 based on hydrosilation cure and Example 2 based on moisture cure showed higher abrasion resistance, lower creep, and higher CO₂ gas permeability compared to Comparative Example C-1 is based on phenolic cure. Example 2 employs a 1:3 VNB-EPDM to polysiloxane/silicon hydride as curative that can act as both cure and a migratory slip agent improving the abrasion resistance. Similarly in situ added methoxy silane can provide abrasion resistance advantage. Both Example 1 and Example 2 showed significantly higher CO₂ gas permeability and lower thermal conductivity compared to Comparative example C-A and Comparative example C—B of Table 1.

The compositions shown in Example 1 and Example 2 have a high CO₂ gas permeability, good abrasion resistant layer, and good tensile properties suitable for use as one or more layers in flexible pipes for fluid transportation in petroleum production. More specifically, the compositions of Example 1 and 2 can be employed as an external sheath in flexible pipes or thermoplastic composite pipes, or as an intermediate sheath in flexible pipes, or as an abrasion resistant low cost anti-wear layer, or as an extrudable insulation layer (either as a single layer or tape).

### Phenolic Cure of TPV Compositions Including a Siloxane-Based Slip Agent

Comparative example C-3 is a TPV composition comprising a polypropylene thermoplastic and an EPDM rubber that was cured using a phenolic cure. Comparative example C-4 is a TPV composition comprising a HDPE thermoplastic and an EPDM rubber that was cured using a phenolic cure. Example 3 is a TPV composition comprising a polypropylene thermoplastic, an EPDM rubber, an ultra-high molecular weight siloxane, and a cyclic olefin copolymer that was cured using a phenolic cure. Example 4 is a TPV composition comprising a HDPE thermoplastic, an EPDM rubber, an ultra-high molecular weight siloxane and a cyclic olefin copolymer that was cured using a phenolic cure. Example 5 is a TPV composition comprising a HDPE thermoplastic, an ultra-high molecular weight siloxane, and an EPDM rubber that was cured using a phenolic cure. The TPV compositions of Examples 3-5 further comprises a siloxane-based slip agent. Comparative examples C-3 and C-4 and Examples 3-5 were each prepared on a brabender mixer and were tested on compression molded plaque samples. Table 3 sets forth the ingredients and amounts (parts per weight) employed used in each sample and the results of physical testing that was performed on each sample.

TABLE 3
Comparison of Phenolic Cure of TPV Compositions
Including a Siloxane-Based Slip Agent

| | | | | |
|---|---|---|---|---|
| C3 | C4 | Ex 3 | Ex 4 | Ex 5 |

Formulation (part by weight)

| | | | | | |
|---|---|---|---|---|---|
| EPDM(E)-1 | 175 | 175 | 175 | 175 | 175 |
| Braskem F008F | 451 | | 385.6 | | |
| HDPE7800P | | 451 | | 406 | 429 |
| Topas 5013, | | | 45.1 | 45.1 | |
| Cyclic Olefin | | | | | |
| Copolymer | | | | | |
| Dow Corning, | | | 22 | 22 | 22 |
| HMB-0221 | | | | | |
| Icecap K Clay | 42 | 42 | 42 | 42 | 42 |
| ZnO | 2 | 2 | 2 | 2 | 2 |
| SnCl₂-45% MB | 1.67 | 1.67 | 1.67 | 1.67 | 1.67 |
| Phenolic resin | 12.82 | 12.82 | 12.82 | 12.82 | 12.82 |
| in Oil | | | | | |
| Spectrasyn 40 | | | | | 49.32 |
| Paramount 6001R | 49.32 | 49.32 | 49.32 | 49.32 | |

Properties

| | | | | | |
|---|---|---|---|---|---|
| Hardness, Shore | 48 | 38 | 46 | 37 | 37 |
| D | | | | | |
| Stress @ 7%, | 10.7 | 7.5 | 10.6 | 7.1 | 7.0 |
| MPa | | | | | |
| Young's | 437 | 308 | 522 | 318 | 299 |
| Modulus, MPa | | | | | |
| Yield Strength, | 12.9 | 9.2 | 11.7 | 8.7 | 8.6 |
| MPa | | | | | |
| Yield Strain, % | 21.9 | 30.1 | 16.8 | 30.0 | 30.7 |
| CO₂ Gas | 58 | 47 | 104 | 51 | 47 |
| Permeability (@ | | | | | |
| 60° C.) | | | | | |
| Abrasion loss, | 91 | 71 | 64 | 43 | 30 |
| mg/1000 cycle | | | | | |
| Thermal | 0.193 | 0.289 | 0.188 | 0.275 | 0.283 |
| conductivity, | | | | | |
| W/m · K | | | | | |
| Creep strain (@ | 8 | 27 | 8 | 21 | 40 |
| 23° C., 4 MPa) | | | | | |
| after 1 week, % | | | | | |

Example 3 including a cyclic olefin copolymer and a siloxane-based slip agent showed higher abrasion resistance and increased CO₂ gas permeability when compared to Comparative example 3. Example 3 showed better mechanical properties of higher harness, higher stress @ 7%, higher Young's modulus, higher yield strength, higher yield strain compared to Comparative example 2 of Table 2.

Example 4 including a cyclic olefin copolymer and a siloxane-based slip agent in a HDPE matrix showed higher abrasion resistance, increased CO₂ gas permeability, and lower creep compared to Comparative example 4 including a HDPE matrix without a cyclic olefin copolymer and without a siloxane-based slip agent.

Example 5 including a siloxane-based slip agent in a HDPE host matrix showed higher abrasion resistance and increased CO₂ gas permeability compared to Comparative example 4 including a HDPE matrix without a siloxane-based slip agent.

Without being bound by theory unless specifically set forth in the claims, it is believed that the addition of a cyclic olefin copolymer to TPV significantly increases CO₂ gas permeability. It is believed that the addition of a high molecular weight siloxane-based slip agent to TPV compositions increases abrasion resistance.

The compositions shown in Example 3, 4, and 5 have a high CO₂ gas permeability, good abrasion resistant layer, and good tensile properties suitable for use as one or more layers in flexible pipes for fluid transportation in petroleum production. More specifically, the compositions of Examples 3, 4, and 5 can be employed as an external sheath in flexible pipes or thermoplastic composite pipes, or as an intermediate sheath in flexible pipes, or as an abrasion resistant low cost anti-wear layer, or as an extrudable insulation layer (either as a single layer or tape).

### Hydrosilation Cure of TPV Compositions

Example 6 is a TPV composition comprising a polypropylene thermoplastic, an EPDM rubber, and a cyclic olefin copolymer that was cured using a hydrosilation_cure. Example 7 is a TPV composition comprising a polypropylene thermoplastic, an EPDM rubber, a cyclic olefin copolymer, and a siloxane-based slip agent that was cured using a hydrosilation_cure. Example 8 is a TPV composition comprising a HDPE thermoplastic, an EPDM rubber, a cyclic olefin copolymer, and a siloxane-based slip agent that was cured using a hydrosilation_cure. Examples 6-8 were each prepared on a Brabender mixer and were tested on compression molded plaque samples. Table 4 sets forth the ingredients and amounts (parts per hundred rubber, phr) employed used in each sample and the results of physical testing that was performed on each sample.

TABLE 4
Comparison of Hydrosilation Cure of TPV Compositions

| | | |
|---|---|---|
| Ex 6 | Ex 7 | Ex 8 |

Formulation (part by weight)

| | | | |
|---|---|---|---|
| EPDM(V)-1 | 200 | 200 | 200 |
| Braskem F008F | 440.7 | 440.7 | |
| HDPE 7800P | | | 463.9 |
| Topas 8007, Cyclic | 51.5 | 51.5 | |
| Olefin Copolymer | | | |
| Topas 5013, Cyclic | | | 51.5 |
| Olefin Copolymer | | | |
| Dow Corning, HMB- | | 24.7 | 24.7 |
| 0221 | | | |
| Xiameter OFX-5084 | 2.5 | 2.5 | 2.5 |
| Si—H | | | |
| Platinum catalyst. | 0.007123 | 0.007123 | 0.007123 |
| PC0985 | | | |
| Calcium Stearate/ | 1.59 | 1.59 | 1.59 |
| Irganox B4329 | | | |
| Icecap K Clay | 42 | 42 | 42 |
| ZnO | 2 | 2 | 2 |
| Paramount 6001R | 61 | 61 | 61 |

Properties

| | | | |
|---|---|---|---|
| Hardness, Shore D | 43 | 44 | 38 |
| Stress @ 7%, MPa | 9.4 | 9.6 | 8.1 |
| Young's Modulus, MPa | 411 | 445 | 345 |
| Yield Strength, MPa | 11.4 | 11.3 | 9.0 |
| Yield Strain, % | 24.5 | 21.1 | 26.8 |
| CO₂ Gas Permeability | 126 | 111 | 33 |
| (@ 60° C.) | | | |
| Abrasion loss, mg/ | 57 | 54 | 44 |
| 1000 cycle | | | |
| Thermal conductivity, | 0.188 | 0.187 | 0.276 |
| W/m · K | | | |
| Creep strain (@ 23° C., | 16 | 15 | 10 |
| 4 MPa) after 1 week, % | | | |

Example 6 including a cyclic olefin copolymer show higher abrasion resistance and increased when compared to Comparative example 3 without a cyclic olefin copolymer.

Example 7 including a cyclic olefin copolymer and a siloxane-based slip agent show higher abrasion resistance and increased when compared to Comparative example 3 without a cyclic olefin copolymer.

Example 8 including a cyclic olefin copolymer and a siloxane-based slip agent in an HDPE matrix show higher abrasion resistance and similar creep performance when compared to Comparative example 3 without a cyclic olefin copolymer. While Example 8 has lower CO₂ gas permeability when compared to Comparative example 3, Example 8 has high CO₂ gas permeability when compared to Comparative Examples C-A and C—B.

Without being bound by theory unless specifically set forth in the claims, it is believed that the addition of a cyclic olefin copolymer to TPV compositions that are cured by hydrosilation increases CO₂ gas permeability. It is believed that the addition of a cyclic olefin copolymer to TPV compositions that are cured by hydrosilation increases abrasion resistance without the need for a siloxane-based slip agent as shown by the similar abrasion resistance of Example 6 without a siloxane compared to Examples 6 and 7 with siloxane-based slip agents.

The compositions shown in Example 6, 7, and 8 have a high CO₂ gas permeability, good abrasion resistant layer, and good tensile properties suitable for use as one or more layers in flexible pipes for fluid transportation in petroleum production. More specifically, the compositions of Example 6. 7, and 8 can be employed as an external sheath in flexible pipes or thermoplastic composite pipes, or as an intermediate sheath in flexible pipes, or as an abrasion resistant low cost anti-wear layer, or as an extrudable insulation layer (either as a single layer or tape pre-made and wrapped around another layer of the flexible pipe).

### Phenolic Cure TPV Compositions Including a Siloxane-Based Slip Agent and Other Additives

Example 9 and 10 are TPV compositions comprising a polypropylene thermoplastic, an EPDM rubber, a polyolefin block copolymer, and a siloxane-based slip agent that was cured using a phenolic cure. Example 11 is a TPV composition comprising a polypropylene thermoplastic, an EPDM rubber, a polyolefin block copolymer, a siloxane-based slip agent, and a cyclic olefin copolymer that was cured using a phenolic cure. Example 12 is a TPV composition comprising a HDPE thermoplastic, an EPDM rubber, a siloxane-based slip agent, and a hydrocarbon resin that was cured using a phenolic cure. Example 13 is a TPV composition comprising a polypropylene thermoplastic, an EPDM rubber, a siloxane-based slip agent, and a hydrocarbon resin that was cured using a phenolic cure. Examples 9 through 13 were each prepared on a Brabender mixer and were tested on compression molded plaque samples. Table 5 sets forth the ingredients and amounts (parts per hundred rubber, phr) employed used in each sample and the results of physical testing that was performed on each sample.

TABLE 5
Comparison of Phenolic Cure of TPV Compositions
Including a Siloxane-Based Slip Agent

| | | | | |
|---|---|---|---|---|
| Ex 9 | Ex 10 | Ex 11 | Ex 12 | Ex 13 |

Formulation (part by weight)

| | | | | | |
|---|---|---|---|---|---|
| EPDM(E)-1 | 164.5 | 164.5 | 164.5 | 175 | 175 |
| Braskem F008F | 401.9 | 401.9 | 370.4 | | 429 |
| HDPE7800P | | | | 429 | |
| Intune D5535 | 33.1 | | | | |
| Intune D5545 | | 33.1 | 33.1 | | |
| Topas 8007, Cyclic | | | 31.6 | | |
| Olefin Copolymer | | | | | |
| Oppera PR100N | | | | 55.1 | 55.1 |
| Dow Corning, | 22.0 | 22.0 | 22.0 | 22.0 | 22.0 |
| HMB-0221 | | | | | |
| Icecap K Clay | 42 | 42 | 42 | 42 | 42 |
| ZnO | 2 | 2 | 2 | 2 | 2 |
| SnCl₂-45% MB | 1.67 | 1.67 | 1.67 | 1.67 | 1.67 |
| Phenolic resin | 12.82 | 12.82 | 12.82 | 12.82 | 12.82 |
| in Oil | | | | | |
| Paramount 6001R | 49.32 | 49.32 | 49.32 | 49.32 | 49.32 |

Properties

| | | | | | |
|---|---|---|---|---|---|
| Hardness, Shore D | 45 | 45 | 44 | 35 | 45 |
| Stress @ 7%, MPa | 10.2 | 9.7 | 9.6 | 6.4 | 9.1 |
| Young's Modulus, MPa | 410 | 367 | 389 | 257 | 317 |
| Yield Strength, MPa | 12.1 | 11.9 | 11.5 | 8.0 | 11.3 |
| Yield Strain, % | 22.3 | 26.7 | 24.7 | 35.6 | 28.8 |
| CO₂ Gas Permeability | 78 | 81 | 74 | 27 | 50 |
| (@ 60° C.) | | | | | |
| Abrasion loss, mg/ | 69 | 60 | 58 | 31 | 68 |
| 1000 cycle | | | | | |
| Thermal conductivity, | 0.189 | 0.186 | 0.189 | 0.242 | 0.180 |
| W/m · K | | | | | |
| Creep strain | 10 | 8 | 10 | 93 | 12 |
| (@ 23° C., 4 MPa) | | | | | |
| after 1 week, % | | | | | |

The TPV compositions of Examples 9 through 13 including a siloxane-based slip agent that was phenolic cured showed higher abrasion resistance when compared to Comparative example C-3 without a siloxane-based slip agent.

Example 12 including a hydrocarbon resin in a HPDE matrix showed lower thermal conductivity when compared to Comparative Example C-4 comprising a HPDE matrix without a hydrocarbon resin. Example 13 including a hydrocarbon resin in polypropylene matrix showed lower thermal conductivity when compared to Comparative Example C-3 comprising a polypropylene matrix without a hydrocarbon resin.

Without being bound by theory unless specifically set forth in the claims, it is believed that the addition of a hydrocarbon resin to the TPV compositions surprisingly lowers the thermal conductivity, and enhances CO₂ permeability.

The compositions shown in Example 9 through 13 have a high CO₂ gas permeability, good abrasion resistant layer, good tensile properties, and good insulation properties suitable for use as one or more insulation layers, or as an external sheath, or as intermediate sheath in flexible pipes for fluid transportation in petroleum production. In addition, the incorporation of compatibilizer and hydrocarbon resins significantly enhances the extrudability of the TPV compositions into thick sections greater than 5 mm with good elongation to break.

### Partially Cured Compositions

Examples 14-16 are TPV compositions comprising a polypropylene thermoplastic, an EPDM rubber, a butyl-based rubber, and a hydrosilation based cure system that preferentially cures the EPDM. Example 17 and 18 are TPV compositions comprising a HDPE thermoplastic, an EPDM rubber, a butyl-based rubber and a hydrosilation based cure system that preferentially cures the EPDM domains. Examples 14 through 18 were each prepared on a brabender mixer and were tested on compression molded plaque samples. Table 6 sets forth the ingredients and amounts (parts per hundred rubber, phr) employed used in each sample and the results of physical testing that was performed on each sample.

TABLE 6
Comparison of Compositions with Partially Cured Domains

| | | | | |
|---|---|---|---|---|
| Ex 14 | Ex 15 | Ex 16 | Ex 17 | Ex 18 |

Formulation (part by weight)

| | | | | | |
|---|---|---|---|---|---|
| Exxpro 3745 | 80 | 50 | 20 | 80 | 20 |
| EPDM(V)-1 | 40 | 100 | 160 | 40 | 160 |
| Braskem F008F | | | | | |
| PDH025 | 515.4 | 515.4 | 515.4 | | |
| HD7800P | | | | 515.4 | 515.4 |
| Icecap K Clay | 12 | 12 | 12 | 12 | 12 |
| Xiameter OFX-5084 Si—H | 2.5 | 2.5 | 2.5 | 2.5 | 2.5 |
| Platinum catalyst, PC0985 | 0.007123 | 0.007123 | 0.007123 | 0.007123 | 0.007123 |
| Calcium Stearate/Irganox B4329 | 1.59 | 1.59 | 1.59 | 1.59 | 1.59 |
| ZnO | 2 | 2 | 2 | 2 | 2 |
| Paramount 6001R | 61 | 49.32 | 23.61 | 23.61 | 23.61 |

Properties

| | | | | | |
|---|---|---|---|---|---|
| Hardness, Shore D | 48 | 48 | 50 | 41 | 41 |
| Stress @ 7%, MPa | 13.2 | 12.4 | 12.7 | 9.2 | 9.1 |
| Young's Modulus, MPa | 612 | 585 | 677 | 462 | 388 |
| Yield Strength, MPa | 14.0 | 15.0 | 12.9 | 10.5 | 10.5 |
| Yield Strain, % | 20.8 | 12.9 | 10.4 | 21.3 | 24.6 |
| CO₂ Gas Permeability (@ 60° C.) | 47 | 53 | 54 | 33 | 42 |
| Abrasion loss, mg/1000 cycle | 85 | 82 | 53 | 99 | 50 |
| Thermal conductivity, W/m · K | 0.184 | 0.172 | 0.191 | 0.292 | 0.304 |
| Creep strain (@ 23° C., 4 MPa) | 5 | 5 | 4 | 19 | 20 |
| after 1 week, % | | | | | |

Without being bound by theory unless specifically set forth in the claims, it is believed that the partially cured TPV system shows significantly lower thermal conductivity, improved processability, and high CO₂ permeability, especially compared to C-A and C—B. In the specific embodiment, the choice of hydrosilation curative preferentially cures the EPDM domains while leaving the butyl rubber uncured.

The compositions shown in Example 14 through 18 have a high CO₂ gas permeability, good abrasion resistant layer, good tensile properties, and good insulation properties suitable for use as one or more insulation layers, or as an external sheath, or as intermediate sheath in flexible pipes for fluid transportation in petroleum production. More specifically, the compositions of Examples 14 through 18 can be employed as an external sheath in flexible pipes or thermoplastic composite pipes, or as an intermediate sheath in flexible pipes, or as an abrasion resistant low cost anti-wear layer, or as an extrudable insulation layer (either as a single layer or tape pre-made and wrapped around another layer of the flexible pipe).

TPV Compositions with Different Additives

Example 19 is a TPV composition comprising a polypropylene thermoplastic, an EPDM rubber, a phenolic cure system, and a performance modifier resin under the trade name Oppera™ PR100N available from ExxonMobil of Houston, Tex. Example 20 is a TPV composition comprising a HDPE thermoplastic, an EPDM rubber, a phenolic cure system, and a performance modifier resin under the trade name Oppera™ PR100N available from ExxonMobil of Houston, Tex. Example 21 is a TPV composition comprising a polypropylene thermoplastic, an EPDM rubber, a phenolic cure system, and a cyclic olefin copolymer. Example 22 is a TPV composition comprising a polypropylene thermoplastic, an EPDM rubber, a phenolic cure system, and an ester plasticizer. Examples 19 through 22 were each prepared on a brabender mixer and were tested on compression molded plaque samples. Table 7 sets forth the ingredients and amounts (parts per hundred rubber, phr) employed used in each sample and the results of physical testing that was performed on each sample.

TABLE 7
Comparison of Compositions with different additives

| | | | |
|---|---|---|---|
| Ex 19 | Ex 20 | Ex 21 | Ex 22 |

Formulation (part by weight)

| | | | | |
|---|---|---|---|---|
| EPDM(E)-2 | 100 | 100 | 100 | 100 |
| Braskem F008F | 429 | | 429 | 429 |
| Topas 5013 | | | 70 | |
| HD7800P | | 429 | | |
| Oppera PR100N | 70 | 70 | | |
| Dow Corning, HMB-0221 | 22 | 22 | 22 | 22 |
| Icecap K Clay | 42 | 42 | 42 | 42 |
| ZnO | 2.0 | 2.5 | 2.5 | 2.5 |
| SnCl₂-45% MB | 1.67 | 1.67 | 1.67 | 1.67 |
| Phenolic resin in Oil | 12.82 | 12.82 | 12.82 | 12.82 |
| Plasthall 100 | | | | 50 |
| Paramount 6001R | 50 | 50 | 50 | |

Properties

| | | | | |
|---|---|---|---|---|
| Hardness, Shore D | 53 | 40 | 57 | 54 |
| Stress @ 7%, MPa | 12.3 | 8.0 | 15.1 | 13.9 |
| Young's Modulus, MPa | 606 | 375 | 821 | 620 |
| Yield Strength, MPa | 23.5 | 30.0 | 14.3 | 15.9 |
| Yield Strain, % | 14.1 | 9.7 | 16.0 | 20.5 |
| CO₂ Gas Permeability | 27 | 25 | 47 | 67 |
| (@ 60° C.) | | | | |
| Abrasion loss, mg/ | 50 | 15 | 81 | 47 |
| 1000 cycle | | | | |
| Thermal conductivity, | 0.187 | 0.283 | 0.188 | 0.197 |
| W/m · K | | | | |
| Creep strain | 9 | 27 | 3 | 4 |
| (@ 23° C., 4 MPa) | | | | |
| after 1 week, % | | | | |

The compositions shown in Example 19 through 22 are believed to have a high CO₂ gas permeability, good abrasion resistant layer, good tensile properties, and good insulation properties suitable for use as one or more insulation layers, or as an external sheath, or as intermediate sheath in flexible pipes for fluid transportation in petroleum production. More specifically, the compositions of Examples 19 through 22 can be employed as an external sheath in flexible pipes or thermoplastic composite pipes, or as an intermediate sheath in flexible pipes, or as an abrasion resistant low cost anti-wear layer, or as an extrudable insulation layer (either as a single layer or tape pre-made and wrapped around another layer of the flexible pipe).

### Properties

The properties of the TPV compositions were determined by the following to physical testing procedures.

Abrasion loss was measured according to ASTM D4060-14 in which the method was performed on both sides of a 4″ circular specimen cut from the plaques provided. Wheel H-22 was used with 1 kg weight and 1000 revolutions. The wheel was resurfaced before testing each specimen (or after every 1000 cycles).

Thermal conductivity was measured according to ASTM C518-17 in which the method was performed on TA FOX50-190 instrument. Plastics plaques were die cut into disc specimens of two inch diameter. The specimens were measured at 25 and 90° C. Each material was measured in duplicate.

Young's Modulus, Stress @ 7%, Yield Strength, and Yield Strain were measured according to ISO 37=. The samples were tested using crosshead speed of 2 in/min at 23° C.

CO₂ Gas permeability was measured according to ISO 2782-1: 2012(E) in which the thickness of each sample was measured at 5 points homogeneously distributed over the sample permeation area. The test specimen was bonded onto the holders with suitable adhesive cured at the test temperature. The chamber was evacuated by pulling vacuum on both sides of the film. The high pressure side of the film was exposed to the test pressure with CO₂ gas at 60° C. The test pressure and temperature was maintained for the length of the test, recording temperature and pressure at regular intervals. The sample was left under pressure until steady state permeation has been achieved (3-5 times the time lag (τ)).

Creep strain was measured by conditioning the test samples according to ASTM Lab conditions at 23±2° C. and 50±10% relative humidity. Conditioning time was not less than 40 hours under lab conditions and was not less than 48 hours after fabrication. Strips with dimensions of 15 mm width×250 mm length (0.591″ wide by 9.85″ long) were cut from compression molded sheet samples. The test area 100 mm was clamped and loaded with weights to achieve a total stress of 4 MPa. The creep strain was measured as a function of time for a week at 23° C.

Shore Hardness was measured according to ASTM D2240, with a 5 second delay using Shore D scale or Shore A scale.

All documents described herein are incorporated by reference herein, including any priority documents and/or testing procedures to the extent they are not inconsistent with this text. As is apparent from the foregoing general description and the specific embodiments, while forms of the embodiments have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “I”″ preceding the recitation of the composition, element, or elements and vice versa, e.g., the terms “comprising,” “consisting essentially of,” “consisting of” also include the product of the combinations of elements listed after the term.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All priority documents are herein fully incorporated by reference for all jurisdictions in which such incorporation is permitted and to the extent such disclosure is consistent with the description of the present disclosure. Further, all documents and references cited herein, including testing procedures, publications, patents, journal articles, etc. are herein fully incorporated by reference for all jurisdictions in which such incorporation is permitted and to the extent such disclosure is consistent with the description of the present disclosure.

While the present disclosure has been described with respect to a number of embodiments and examples, those skilled in the art, having benefit of the present disclosure, will appreciate that other embodiments can be devised which do not depart from the scope and spirit of the present disclosure as described herein.

1. A flexible pipe for transporting fluids in hydrocarbon production comprising at least one layer comprised of a thermoplastic vulcanizate (TPV) composition, the TPV composition comprising:
a thermoplastic polyolefin;
a rubber phase that is dispersed and at least partially crosslinked; and
a cyclic olefin copolymer present in a range from 0.1 wt % to 30 wt % based upon a total weight of the TPV composition.

2. The flexible pipe of claim 1, wherein the cyclic olefin copolymer is present in a range from 1 wt % to 10 wt % based upon a total weight of the TPV composition.

3. The flexible pipe of claim 1, wherein the cyclic olefin copolymer has glass transition temperature in a range from 10° C. to 190° C. when measured using a differential scanning calorimeter at 10° C./min.

4. The flexible pipe of claim 1, further comprising:
a hydrocarbon resin present in a range from 0.1 wt % to 30 wt % based upon a total weight of the TPV composition.

5-6. (canceled)

7. The flexible pipe of claim 1, further comprising:
a slip agent present in a range from 0.1 wt % to 30 wt % based upon a total weight of the TPV composition.

8. The flexible pipe of claim 7, wherein the slip agent is present in a range from 1 wt % to 10 wt % based upon a total weight of the TPV composition.

9. The flexible pipe of claim 7, wherein the slip agent is selected from the group consisting of polysiloxanes, ultra-high molecular weight polyethylene, a blend of polysiloxane and ultra-high molecular weight polyethylene molybdenum disulfide, fluorinated polymer, perfluorinated polymer, aliphatic fatty chains, graphite, and combinations thereof.

10-16. (canceled)

17. The flexible pipe of claim 1, further comprising:
a polyolefin based compatibilizer.

18. The flexible pipe of claim 17, wherein the polyolefin based compatibilizer is present in a range from 0.5 wt % to 10 wt % based upon a total weight of the TPV composition.

19. The flexible pipe of claim 17, wherein the polyolefin based compatibilizer is selected from a group consisting of a styrenic block copolymer, an alpha-olefin copolymer, a copolymer comprising olefinic monomeric units and aromatic monomeric units, a diblock polyolefin, or a combination thereof.

20-25. (canceled)

26. A flexible pipe for transporting fluids in hydrocarbon production comprising at least one layer comprised of a thermoplastic vulcanizate (TPV) composition, the TPV composition comprising:
a thermoplastic polyolefin; and
a rubber phase that is dispersed and at least partially crosslinked,
the TPV composition having a CO₂ gas permeability greater than 10 barrers.

27-32. (canceled)

33. The flexible pipe of claim 1, wherein the rubber phase comprises a diene-containing rubber having sterically unhindered non-conjugated carbon-carbon double bonds.

34. The flexible pipe of claim 1, wherein the rubber phase is an ethylene propylene diene terpolymer.

35. The flexible pipe of claim 1, wherein the rubber phase comprises a diene selected from a group consisting of ethylidenenorbornene and vinylnorbornene.

36. The flexible pipe of claim 1, wherein the rubber phase is a copolymer of isobutylene and C₁₋₄ alkyl styrene.

37. The flexible pipe of claim 1, wherein the rubber phase is a non-halogenated elastomer comprising repeating units derived from at least one C₄ to C₇ isomonoolefin monomer and at least 3.5 mol % of repeating units derived from at least one C₄ to C₇ multiolefin monomer.

38. The flexible pipe of claim 1, wherein the rubber phase is a blend of an ethylene propylene diene terpolymer and a copolymer of isobutylene and C₁₋₄ alkyl styrene.

39. The flexible pipe of any of claim 1, wherein the rubber phase is present in a range from 5 wt % to 70 wt % based on a total weight of the TPV composition.

40. The flexible pipe of claim 1, wherein the thermoplastic polyolefin is an isotactic polypropylene.

41. The flexible pipe of claim 1, wherein the thermoplastic polyolefin is a polyethylene with a density greater than 0.90 g/cm³.

42. The flexible pipe of claim 1, wherein the thermoplastic polyolefin is a copolymer of ethylene with a density greater than 0.90 g/cm³.

43. The flexible pipe of claim 1, wherein the thermoplastic polyolefin is a blend of isotactic polypropylene and a polyethylene.

44. The flexible pipe of claim 1, wherein thermoplastic polyolefin is present in a range from 20 wt % to 80 wt % based on the total weight of the TPV composition.

45-69. (canceled)

70. The flexible pipe of claim 1, wherein the flexible pipe comprises:
a thermal insulation layer;
a tensile armor ply;
a pressure sheath;
the at least one layer is the thermal insulation layer, the TPV composition layer having a thermal conductivity of 0.3 W/m.K or less.

71-75. (canceled)

76. The flexible pipe of claim 1, wherein the flexible pipe comprises:
an external sheath,
a tensile armor ply; and
a pressure sheath,
the at least one layer is the external sheath, the external sheath comprising the TPV composition with a CO₂ gas permeability 10 barrers or greater.

77-82. (canceled)
